(19) United States
(12) Patent Application Publication
(10) Pub. No.: US 2025/0245995 A1
(43) Pub. Date: Jul. 31, 2025

(54) SYSTEM AND METHOD FOR IDENTIFYING SUBJECTS AND ITEMS IN AN AREA OF REAL SPACE AND CALIBRATING PRESENTATION DATA FOR THE SUBJECTS

(71) Applicant: Standard Cognition, Corp., San Francisco, CA (US)

(72) Inventors: Christopher W. ARNOLD, Incline Village, NV (US); David WOOLLARD, San Francisco, CA (US); Katlin PETRIC, Colts Neck, NJ (US)

(73) Assignee: Standard Cognition, Corp., San Francisco, CA (US)

(21) Appl. No.: 19/038,589

(22) Filed: Jan. 27, 2025

Related U.S. Application Data
(60) Provisional application No. 63/625,872, filed on Jan. 26, 2024.

(51) Int. Cl. G06V 20/52; G06Q 30/0251; G06Q 30/0601; G06T 7/20; G06T 7/70; G06V 10/26; G06V 10/764; G06V 40/10; G06V 40/20

(52) U.S. Cl. CPC G06V 20/52; G06Q 30/0261; G06Q 30/0639; G06T 7/20; G06T 7/70; G06V 10/26; G06V 10/764; G06V 40/10; G06V 40/20; G06T 2200/24; G06T 2207/30196; G06T 2207/30232; G06T 2207/30241

(57) ABSTRACT

The technology disclosed relates to a system and methods for providing presentation data to a subject in an area of real space, including obtaining respective sequences of frames of corresponding fields of view in an area of real space; detecting a subject in the area of real space; analyzing a sequence of frames in the respective sequences of space; calibrating presentation data; and triggering a presentation of the calibrated presentation data to the detected subject. Analysis of the sequence of frames includes identifying objects in the area of real space, identifying subject data of the detected subject with respect to the identified objects, and identifying a connection between the identified subject data of the detected subject and a particular identified object. The calibration of the presentation data is dependent on the identified connection between the identified subject data of the detected subject and the particular identified object.

### PRIORITY APPLICATION

This application claims the benefit of U.S. Provisional Patent Application No. 63/625,872 (Atty. Docket No. STCG 1045-1) filed 26 Jan. 2024, which is incorporated herein by reference.

### BACKGROUND

### Field

The technology disclosed generally relates to systems and methods for tracking subjects and the actions of subjects in an area of real space, and more specifically, to providing presentation data to a subject in an area of real space.

### Description of Related Art

Manufacturers, distributors, and management are interested to know the level of interest of subjects in items in an area of real space. Collected data related to the level of interest of subjects in items may be leveraged to strategically boost the level of interest in a particular item or class of items, as well as boost the consumption of the particular item or class of items. One way to determine this interest is by the number of items consumed/sold in a period of time using, for example, timestamps. However, there are many items that subjects do not consume/buy or even not pick up during their trip to the area of real space.

An opportunity arises to provide a system that can more effectively and automatically provide the data related to interest of subjects in different items located at multiple locations in the area of real space. Accordingly, an opportunity also arises to provide a system that can generate presentation data (e.g., electronic/physical personalized promoting content/offers, brochures, content, retailing content/materials, etc.) for subjects (e.g., consumers) who are located in an area of real space.

### SUMMARY

The technology disclosed relates to a system and methods for providing presentation data to a subject in an area of real space, including obtaining, from a plurality of sensors, respective sequences of frames of corresponding fields of view in an area of real space; detecting a subject in the area of real space; analyzing a sequence of frames in the respective sequences of space; calibrating presentation data; and triggering a presentation of the calibrated presentation data to the detected subject. The analyzing of the sequence of frames of the respective sequence of frames includes (i) identifying objects in the area of real space, (ii) identifying subject data of the detected subject with respect to the identified objects, wherein the subject data relates to one or more of: a location of the detected subject, a path of the detected subject, a velocity of the detected subject, an orientation of the detected subject, and an action of the detected subject and (iii) identifying a connection between the identified subject data of the detected subject and a particular identified object. The calibrating of the presentation data is dependent on the identified connection between the identified subject data of the detected subject and the particular identified object.

In one implementation of the technology disclosed, the action of the detected subject includes the detected subject altering a location or a position of any identified object. In another implementation, the subject data of the detected subject further relates to one or more of: a connection of the detected subject with other identified objects, and a connection between the detected subject and another detected subject. One implementation further includes predicting, based on the path of the detected subject, a future path trajectory of the detected subject. One implementation further includes identifying a connection between the particular identified object and another identified object. In some implementations, the presentation data is further calibrated in dependence on the identified connection between the particular identified object and another identified object.

Many implementations further include analyzing a visual association field of the detected subject, wherein the visual association field is segmented into at least two regions within the visual association field, and wherein a visual association of the detected subject with respect to a region within the visual association field is measured in dependence upon a head orientation of the detected subject, and wherein the at least two regions within the visual association field are assigned weights in dependence upon the visual association of the detected subject with a respective region relative to the other regions of the visual association field. In one implementation, identifying the connection between the identified subject data of the detected subject and the particular identified object further includes correlating the identified subject data of the detected subject with the particular identified object and classifying the identified subject data of the detected subject as being connected to the particular identified object. In another implementation, identifying a connection between the identified subject data of the detected subject and another identified object further includes determining that the identified subject data of the detected subject is uncorrelated with the other identified object and classifying the identified subject data of the detected subject as being unconnected to the other identified object.

One implementation includes using a sequence of frames produced by a corresponding sensor in the plurality of sensors in a first inference engine to identify objects in the sequence of frames. Another implementation includes using outputs of the first inference engine over a period of time (using timestamps) in a second inference engine to identify the subject data of the detected subject. Some implementations include monitoring a quantity of the particular identified object located within the area of real space, wherein the calibration of the presentation data is further dependent upon the quantity of the particular identified object.

One disclosed method includes producing subject events that occur in the area of real space corresponding to the identified subject data of the detected subject, each of the subject events including one or more of a subject identifier of the detected subject, particular identified subject data of the detected subject, a location in the area of real space, and a timestamp; constructing a chronologically ordered sequence of subject events associated with the detected subject; and calibrating the presentation data in dependence on the chronologically ordered sequence of subject events associated with the detected subject.

In one implementation, identifying the connection between the identified subject data of the detected subject and the particular identified object includes correlating the identified subject data of the detected subject with a region in the area of real space; identifying a set of one or more identified objects associated with the region, wherein the set of one or more identified objects includes the particular identified object; producing a connection probability with respect to each identified object within the set of identified objects, wherein each respective connection probability corresponds to a likelihood that the identified subject data of the detected subject is connected to a respective identified object; and selecting the identified object within the set of identified objects having the highest connection probability as the particular identified object.

Another implementation includes identifying other subject data of the detected subject and another connection between the other subject data of the detected subject and another identified object; further calibrating the calibrated presentation data in dependence on the other connection between the other subject data of the detected subject and the other identified object; and triggering a presentation of the further calibrated presentation data to the detected subject.

In some implementations, the calibrated presentation data is presented to the detected subject via a user interface, wherein the user interface is configured to receive a user input from the detected subject. The calibrated presentation data can be further calibrated in dependence on the received user input. Other implementations are described further throughout the detailed description.

### BRIEF DESCRIPTION OF THE DRAWINGS

The patent or application file contains at least one drawing executed in color. Copies of this patent or patent application publication with color drawing(s) will be provided by the Office upon request. The invention will be described with respect to specific embodiments thereof, and reference will be made to the drawings, which are not drawn to scale, and in which:

FIG. 1A illustrates an architectural level schematic of a system that includes a plurality of camera systems to track subjects, detect events and identify items related to detected events.

FIG. 1B presents a high-level architecture of the camera system including devices to process data captured by sensors.

FIG. 2 is an example camogram representing objects in an area of real space including example object data.

FIG. 3 is a system including camera systems comprising image capturing sensors for tracking objects in an area of real space.

FIG. 4A is a side view of a corridor (e.g., an aisle) in an area of real space illustrating a subject, display structures and a camera system arrangement in an area of real space.

FIG. 4B is a perspective view, illustrating a subject taking an item from a shelf in the display structure in the area of real space.

FIG. 5A is a perspective view illustrating a subject taking a pop drink from a shelf, triggering presentation data for the pop drink.

FIG. 5B is a perspective view illustrating a subject gazing in the direction of a pop drink, triggering presentation data for the pop drink.

FIG. 5C illustrates example presentation data on a graphical user interface screen.

FIG. 6 is a camera and computer hardware arrangement configured for deploying the disclosed camera vision system.

### DETAILED DESCRIPTION

The following detailed description is made with reference to the figures provided below. Example implementations are described to illustrate the technology disclosed, not to limit its scope, which is defined by the claims. Those of ordinary skill in the art will recognize a variety of equivalent variations on the description that follows.

Technologies have been developed to apply image processing to identify and track the actions of subjects in real space. The image processing can use biometric information, facial information, body shape/size information, body movement information, etc. For example, so-called cashier-less systems are being developed to identify objects (e.g., objects) that have been picked up by the subjects, and automatically accumulate lists that can be used to bill the subjects. In addition to identifying when objects have been picked up or put down by the subjects, it is also possible to track subject interactions without the subject physically touching the item. For example, computer vision systems can be leveraged to track whether a subject in a particular corridor is browsing (e.g., perusing a plurality of items without focusing on one particular item), targeting (e.g., looking with intention to find a specific item or type of item), or merely transmitting (e.g., passing through a corridor without considering any items located within the corridor).

Manufacturers, distributors, and management are interested to know the level of interest of subjects in items in an area of real space (e.g., a store). Collected data related to the level of interest of subjects in items may be leveraged to strategically boost the level of interest in a particular item or class of items, as well as boost the throughput of the particular item or class of items. One way to determine this interest is by the number of items sold in a period of time. However, there are many items that subjects do not obtain/buy (e.g., consume) or even not pick up from shelves during their trip to the area of real space. Manufacturers and distributors of such items and the management are interested to know which items are getting more attention from subjects even if the subjects are not obtaining them. Hence, an opportunity arises for a computer vision system capable of detecting subject impressions onto objects without the subject picking up or obtaining the objects. This data can provide useful insights for product design, assignment of value for subjects and retailing strategies. Moreover, even if a subject is obtaining certain items, it is desirable to provide so-called “real-time” presentation data towards the certain items or related items; i.e., collecting data about a subject's behavior and using the collected data to provide relevant presentation data materials to a subject while the subject is still in the area of real space, in contrast to (or in addition to) downstream retailing strategies developed on a long-term scale.

Examples of types of such data that can be collected include the amount of time subjects linger nearby a particular display or corridor, the directional gaze or posture of a subject towards the location of a particular corridor or object, behavior involving examining an item followed by placing the item back on the shelf or initially placing an item in a cart that is later exchanged with a different item in its place, and pattern recognition related to the items a subject places in their cart (e.g., if a subject has placed hot dogs in their cart, there is a high likelihood that the subject may also be interested in obtaining hot dog buns or condiments). Traditional point of retail systems in areas of real spaces cannot provide this information. While certain forms of data related to behavior can be collected from the retail system (i.e., a record of items obtained), real-time presentation data can provide an approach for increasing activity that is more specifically targeted and personalized than other traditional retailing strategies. Presentation data can be curated for a specific subject during a specific trip.

### System Overview

The technology disclosed relates to an image processing system deployed in an area of real space with multiple subjects moving in corridors between the shelves and open spaces within the area of real space. The image processing can use biometric information, facial information, body shape/size information, body movement information, etc. The system is coupled to a plurality of cameras and to memory storing locations of items in the area of real space. The system includes processing logic that uses the sequences of frames of corresponding fields of view in the real space.

Subjects' interactions can include taking items (“takes”) from shelves (i.e., a fixed item cache) and placing them in their respective carts or baskets (i.e., a moving item cache). Subjects may also put items back (“puts”) on the shelf in an exchange from a moving item cache to a fixed item cache if they do not want the item. The technology disclosed is related to tracking subjects in an area of real space and identifying actions of subjects including puts and takes of objects/items on shelves. The subjects can also transfer items in their hands to the hands of other subjects who may then put these items in their carts or baskets in an exchange between two moving item caches. The subjects can also simply touch objects, without an exchange of the objects. Subject interactions can further include directional impressions (e.g., based on one or more of the subject's dwell, gaze, path, body posture, head orientation, etc.). In addition to subject interactions with objects, the technology disclosed can further include detecting subject interactions with displays to track data related to impressions and conversion.

There are many different forms of subject data that can be measured and analyzed for a detected subject, including various subject interactions, subject behaviors, and subject attributes. As described above, subject interactions can include, for example, interactions with objects, interactions with other subjects (e.g., subjects or assistants, such as an employee, in a store), or interactions with presentation data. Subject data can be identified based on direct observation, such as detection of a subject picking up and moving an item or the subject's current location within a monitored space. Other forms of subject data can be indirectly inferred from measured data, such as identification of objects that the subject may be interested in based on their body orientation or prediction of what objects that the subject may interact with in the future based on previous interactions. Herein, the term “orientation” is used with respect to a subject to describe any metric or feature related to the positioning of a subject's body in space, such as the direction that their body is facing, the direction of their head or eyes, posture, and so on. For example, gaze of a subject is one type of subject orientation. Said examples of subject data are nonlimiting examples provided for illustrative purposes, and a user skilled in the art will recognize other forms of subject data that can be detected, monitored, captured, inferred, classified, or predicted. Furthermore, subject data can be measured from a variety of sources including different forms of cameras or sensors, user devices, and manual input of data.

In addition to measured data and computational analysis outputs, subject data can additionally include data from supplemental sources (e.g., demographic data or proprietary data sets) to augment measured subject data, and data obtained from processing of measured subject data. In some circumstances, two or more individual sources of subject data may be combined into one metric like a summary statistic (e.g., mean, mode, or variance), relative analyses statistics (e.g., correlation analysis, comparisons, or covariance), and/or multidimensional data representations like a weighted sum, vector encodings, or tensor data. In one example, a subject's tracked path/trajectory throughout the area of real space can be combined with other subject data to produce additional subject data. A path of a detected subject can be combined with tracked velocity fluctuations for the subject as they move throughout the area of real space to obtain dwell data (e.g., when a subject stops moving and remains within a certain area or continues interacting with a particular aspect of their environment) or predict a future trajectory for the subject. Measured head orientation of a subject can be further processed to infer a subject's gaze, e.g., to predict what the subject is looking at. One or more of a subject's orientation, dwell, gaze, interactions, etc., can be used as multiple inputs in order to obtain a measurement of a subject's impressions onto items and predict interest. Subject data may also relate to multiple tracks corresponding to multiple subjects, e.g., identifying a group of correlated subject tracks based on triangulation of trajectories, and/or derived characteristics of correlated subject tracks determined based on one or more individual characteristics of a particular subject corresponding to one of the subject tracks.

It will be readily apparent to a user skilled in the art that other forms of subject data can be obtained through pre-processing, post-processing, feature engineering, and other combinations of data not listed here for the sake of clarity. Some example implementations disclosed herein refer to specific types of subject data for illustrative purposes; however, other forms of subject data can be used in place of, or in addition to, the examples provided.

The system includes logic to enable reliable classification of items on shelves, as well as types of interactions with the items including takes, puts, exchanges from one person to another, simply touching an item, or impressing upon an item. In many implementations, the technology disclosed includes logic to create camograms that present an image of a shelf. When a shelf is in the field of view of camera, the system can detect what products are positioned on that shelf and where the specific products are positioned on the shelf with a high level of accuracy. The system can associate an item taken from the shelf to a subject. The technology disclosed can perform detection and classification of items. The detection task in the context of cashier-less areas of real space is to identify whether an item is taken from a shelf by a subject. In some cases, it is also important to detect whether an item is placed on a shelf by a person who can be an assistant or a subject. The classification task is to identify what item was taken from the shelf or placed on the shelf. Camograms can support the detection and classification tasks by identifying the location on the shelf from where an item has been taken from or placed at. The technology disclosed includes systems and methods to generate, update and utilize camograms for detection and classification of objects in an area of real space.

In some implementations, the area of real space is a packaging facility, a medical facility, an office building, etc. Objects to be detected and classified can include objects, medicine and other regulated products, people and animals, etc. The technology disclosed can be helpful in a variety of use cases, such as security, research, retailing, education, or any other setting where it is beneficial to collect observations about subjects in an environment, identify connections between various elements of the subjects and the environment, calibrate data in dependence on the identified subject data and identified connections, and trigger a presentation of the calibrated data. In many implementations, calibrated presentation data can be presented to a detected subject to enrich their environment. If connections between the subject data and objects in the environment indicate that a detected subject is confused or in need of help, presentation data can be calibrated to include tutorial or assistance information to assist the detected subject.

In one example implementation, the area of real space can be a post office. The disclosed method can include identifying objects in the post office including packages and a self-service kiosk, amongst others. The disclosed method can also include identifying subject data for a detected subject inside the post office: the subject has placed several packages next to the self-service kiosk (a subject interaction with objects), the subject is dwelling in front of the self-service kiosk (based on current location, their previous trajectory, and their ceased movement), the subject is visually interacting with the self-service kiosk (gaze determined from head orientation), and at least one type of subject data indicating that the subject is struggling to operate the self-service kiosk. Perhaps the subject has a tense posture (an orientation metric), an upset facial expression (sentiment analysis), the subject has used their finger to press an above-average number of buttons on the self-service kiosk, and/or the subject is dwelling in front of the self-service kiosk for an above-average length of time compared to other patrons. This subject data can be connected to the self-service kiosk as well as the packages, and a connection can further be made between the packages and the self-service kiosk based on the subject data. Consequently, the disclosed method can include calibrating presentation data to fit the subject data, the identified objects in the environment, and connections thereof to include instructions on using the self-service kiosk for printing information for delivery. The disclosed method can further include triggering presentation of the calibrated information data to the subject via the kiosk display or another device display accessible to the subject. Furthermore, the presentation data can be further calibrated based on subsequent subject data. For example, once the subject has received the printed information and affixed them to the corresponding packages (actions connected to identified objects, labels and packages) the presentation data can be further calibrated to include information on the various drop-off location points within the post office for packages that are ready to transport.

In other implementations, the technology disclosed may be applied to auditing medicine handling in a controlled location, presenting educational material to patrons in a museum as they view exhibits, or providing virtual personal training resources to an individual as they exercise. In other implementations, the disclosed method can include presenting the calibrated presentation data to a third party other than the detected subject. This can include providing more in-depth and contextually prioritized representations of surveillance data to security professionals (e.g., presentation of theft detection data that contains details relevant to the detected subject or identified objects implicated in the incident) or notifying assistants of areas in their workplace requiring attention (e.g., presentation of store status data indicating where a store patron has dropped a gallon of milk such that the assistant is notified not only of the location of the incident, but the type of object involved to help the assistant know what cleaning equipment may be necessary). The technology disclosed can include calibration of presentation data such that the information and content presented to a viewer is relevant and tailored to the specific circumstances related to the presentation data, and/or refined to streamline the presentation of data and improve the accessibility of the data presentation. In the aforementioned store clean-up example, an assistant may otherwise have to find and watch the store camera footage to identify the location or specific details of an incident, or investigate the incident firsthand in order to assess next steps. The technology disclosed can include identifying the subject data indicating that an object has been dropped, the precise location of the incident, and specifically identify the dropped item. Presentation data is calibrated using the identified information and connections/patterns involved to customize and refine the presentation data presented to the viewer.

Moreover, the flexibility of the technology disclosed expands the possible implementation use cases to a wide variety of environments. The technology disclosed is compatible with a wide range of data types, and can function with limited measurement ability. Cameras alone, such as those used in CCTV systems or even home security systems, provide sufficient measurements to detect subject data like object interaction or head orientation from which gaze can be inferred. Although some implementations of the technology disclosed can augment subject data with added personal information, many implementations operate without requiring any personal data about the detected subjects or collecting any sensitive identifying data. Anonymous tracking of subjects bolsters privacy, broadening the application potential to environments like personal home use for child supervision or pet cameras.

Many of the implementations disclosed herein are described with reference to an area of real space for clarity and illustrative purposes. Areas of real spaces are filled with a large volume of objects (e.g., object items and displays) intended to be engaged with by subjects within the area of real space (e.g., subjects and assistants). Many areas of real spaces, like grocery stores, are already equipped with a monitoring system comprising some combination of cameras, sensors, and/or tracking devices connected to objects. The disclosed system is compatible with a wide range of monitoring configurations because the type of subject data collected can be customized to fit the detection capabilities of the system. Hence, an area of real space with an existing CCTV system, for example, can implement the technology disclosed without the need to drastically change or update their technology. The disclosed method can be implemented to achieve various goals in an area of real space environment, such as providing area of real space information to subjects, integrating presentation data into the experience, or otherwise enriching the experience by providing presentation data to subjects that is highly personalized to their experience such as suggested recipes, nutrition facts, or suggested alternatives to out-of-stock items.

Subjects in an area of real space often implicitly interact with objects, in contrast to explicit interactions such as physically touching or moving an item. For example, a subject may stop in front of an item display and remain in front of the display for an extended period of time (e.g., longer than five, ten, or thirty seconds) while reading the object or related material for the object within or near the display, also referred to herein as “dwell.” The subject may be pausing to contemplate obtaining an item. It would be advantageous for manufacturers, distributors, and area of real spaces to be able to detect these subjects who are “on the fence” about obtaining a product and provide instantaneous presentation data with the goal of persuading the subject to decide in favor of obtaining the item. The disclosed system includes logic that calculates the locations of subjects in the area of real space and/or the distance of subjects from objects.

Some implementations of the technology disclosed further involve detecting gaze directions of subjects in the area of real space. The system includes logic that uses sequences of frames in a plurality of sequences of frames to identify locations of an identified subject and gaze directions of the subject in the area of real space over time. The system includes logic to access the database identifying locations of items in the area of real space. The system identifies items in the area of real space matching the identified gaze directions of the identified subject. In one implementation, the processing system includes logic that calculates distances of the identified subject from items having locations matching the identified gaze directions and area of real spaces the calculated distances. The system includes logic that determines lengths of time for which the subject maintains respective gaze directions and area of real spaces the lengths of times. The system includes logic that area of real spaces information including subject identifiers and item identifiers for the identified gaze directions.

In one implementation, detecting events in the area of real space is implemented using an “interaction model”. The interaction model can be implemented using a variety of machine learning models. A trained interaction model can take an input of at least one image frame or a sequence of image frames that are captured prior to the occurrence of the event and after the occurrence of the event. For example, if the event occurred at a time t1, then ten image frames prior to t1 and ten image frames after t1 can be provided as input to the interaction model to detect whether an event occurred or not. In other implementations, more than ten image frames can be used prior to the time t1 and after the time t1 such as twenty, thirty, forty or fifty image frames to detect an event. The event can include taking of an item by a subject, putting an item on a shelf by a subject or an assistant, touching an item on the shelf, rotating or moving the item on the shelf, etc. In the implementation, in which the event is detected by logic implemented on a server outside the camera system, a message can be sent back to the camera system including the data about the event such as event type, location of the event in the area of real space, time of the event, camera identifier, etc.

The technology disclosed further includes detecting subject impressions based on a set of characteristics, in contrast to merely detecting a single characteristic such as gaze or dwell. A subject impression onto a particular object, brand, category of objects, corridor, presentation data, and so on, can be detected in dependence upon one or more of subject gaze, dwelling, path and traversal within the area of real space, visual engagement distribution fields, head orientation, body posture, retinal tracking, and/or various sentiment inference attributes like body language and facial expression. Many implementations of the technology disclosed can be integrated with existing security camera sand/or sensors within an area of real space, because the system can detect subject interactions and subject impressions based on head orientation and subject path without necessarily requiring more sophisticated, optional characteristics like retinal tracking and sentiment inference attributes.

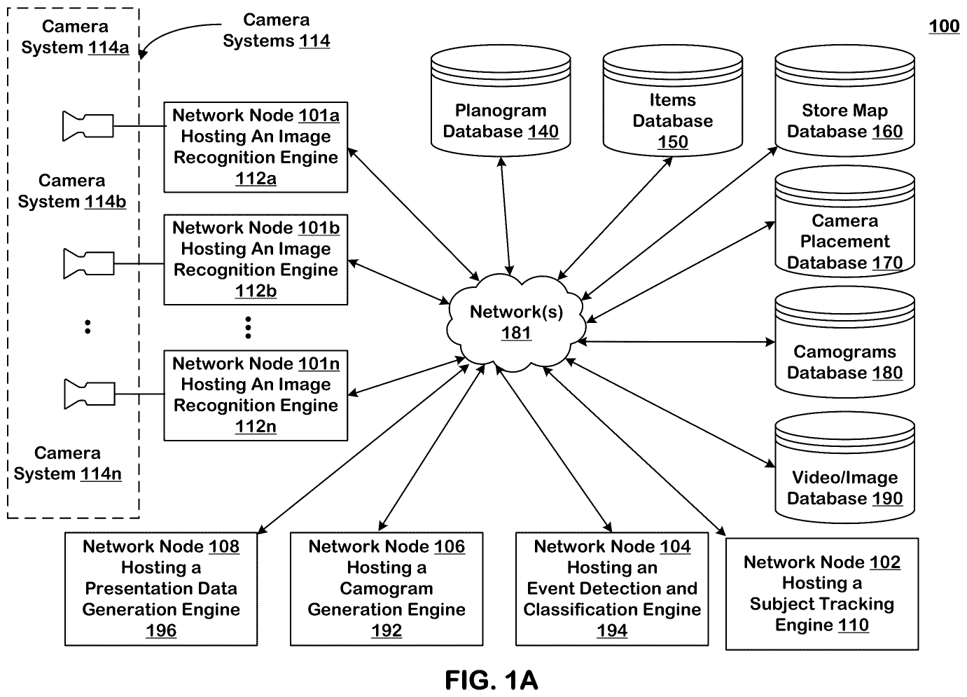

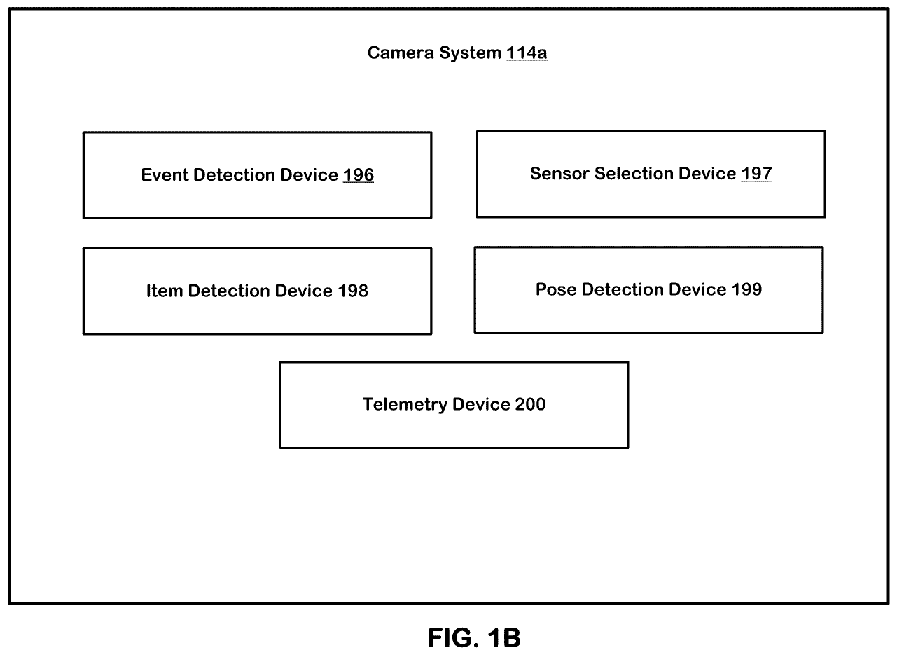

A system and various implementations of the subject technology are described with reference to FIGS. 1A-6. The system and processes are described with reference to FIG. 1A, an architectural level schematic of a system in accordance with an implementation. Because FIG. 1A is an architectural diagram, certain details are omitted to improve the clarity of the description.

The description of FIG. 1A is organized as follows. First, the elements of the system are described, followed by their interconnections. Then, the use of the elements in the system is described in greater detail.

FIG. 1A provides a block diagram level illustration of a system 100. The system 100 includes camera systems 114a, 114b and 114n, network nodes 101a, 101b, and 101n hosting image recognition engines 112a, 112b and 112n, a network node 102 hosting a subject tracking engine 110, a network node 104 hosting an event detection and classification engine 194, a network node 106 hosting a camogram generation engine 192, and a network node 108 hosting a presentation data generation engine 196. The plurality of camera systems 114a, 114b and 114n are collectively referred to as camera systems 114. The network nodes 101a, 101b, 101n, 102, 104 and/or 106 can include or have access to memory supporting tracking of objects and tracking of subjects. The system 100 further includes, in this example, a database 140, an items database 150, a map database 160, a camera placement database 170, a camograms database 180, a video/image database 190, and a communication network or networks 181. Each of the database 140, the items database 150, the map database 160, the camera placement database 170, the camograms database 180, and the video/image database 190 can be stored in the memory that is accessible to the network nodes 101a, 101b, 101n, 102, 104 and/or 106. The network nodes 101a, 101b, 101n, 102, 104 and/or 106 can host only one image recognition engine, or several image recognition engines.

The system 100 can be deployed in a large variety of spaces to anonymously track subjects and detect events such as take, put, touch, etc. when subjects interact with items placed on shelves. The technology disclosed can be used for various applications in a variety of three-dimensional spaces. For example, the technology disclosed can be used in areas of real spaces, airports, gas stations, convenience stores, malls, sports arenas, railway stations, libraries, etc.

The technology disclosed includes logic to track subjects in the area of real space. The technology disclosed includes logic to detect interactions of subjects with items placed on shelves or other types of display structures. The interactions can include actions such as taking items from shelves, putting items on shelves, touching items on shelves, rotating or moving items on shelves, etc. The subjects may also just look at items they are interested in. In such cases, the technology disclosed can use gaze detection to determine items that the subject has looked at or viewed. The technology disclosed includes logic to process images captured by sensors (such as cameras) positioned in the area of real space.

The sensors (or cameras) can be fixed to ceiling or other types of fixed structures in the area of real space. Subject tracking can require generation of three-dimensional scenes for identifying and tracking subjects in the area of real space. Therefore, in some implementations, multiple cameras are needed to be installed that have overlapping fields of view. Similarly, identifying items can require high-resolution images that can require plurality of sensors that can capture images at a high-resolution. Therefore, even for a small area of real space, a large number (e.g., 3 or more) of individual cameras may be needed to provide coverage for all shelves and corridors in the area of real space. Installation of such large number of sensors (or cameras) can require considerable manual labor and can also disrupt operations of an area of real space for a longer duration of time while the cameras are being installed and calibrated. To reduce the installation effort and the downtime in operations of an area of real space, one implementation of the technology disclosed provides a camera system that includes a camera assembly with a plurality of sensors (or cameras). The camera system can be easily installed in the area of real space. A few such camera systems can provide coverage similar to large number of individual sensors (or cameras) installed in the area of real space. In other implementations, the technology disclosed can leverage existing camera or sensor systems previously installed within an area of real space (e.g., for a security system) to produce the raw image data for processing.

The technology disclosed also provides efficient processing of raw image data captured by cameras in the area of real space. Instead of sending the raw image data to a server that may be located offsite, the camera system includes logic to process the raw image data captured by cameras (or sensors) to generate image frames and to detect events and identify items related to events. The technology disclosed includes logic to use data from one or more camera systems to generate three dimensional scenes that can be used to identify subjects and track subjects in the area of real space.

The example implementation described with reference to FIGS. 1A-1B uses a plurality of camera systems 114a, 114b and 114n (collectively referred to as camera systems 114). The camera systems 114 comprise sensors (or cameras) in the visible range which can generate for example RGB color output images. In other embodiments, different kinds of sensors can be used to produce sequences of images (or representations). Examples of such sensors include, ultrasound sensors, thermal sensors, and/or Lidar, ultra-wideband sensors, depth sensors, etc., which are used to produce sequences of images (or representations) of corresponding fields of view in the real space. In one implementation, sensors can be used in addition to the camera systems 114. Multiple sensors can be synchronized in time with each other, so that frames are captured by the sensors at the same time, or close in time, and at the same frame capture rate (or different rates). All of the embodiments described herein can include sensors other than or in addition to the camera systems 114.

As used herein, a network node (e.g., network nodes 101a, 101b, 101n, 102, 104 and/or 106) is an addressable hardware device or virtual device that is attached to a network, and is capable of sending, receiving, or forwarding information over a communications channel to or from other network nodes. Examples of electronic devices which can be deployed as hardware network nodes include all varieties of computers, workstations, laptop computers, handheld computers, and smartphones. Network nodes can be implemented in a cloud-based server system and/or a local system. More than one virtual device configured as a network node can be implemented using a single physical device.

The databases 140, 150, 160, 170, 180, and 190 are stored on one or more non-transitory computer readable media. As used herein, no distinction is intended between whether a database is disposed “on” or “in” a computer readable medium. Additionally, as used herein, the term “database” does not necessarily imply any unity of structure. For example, two or more separate databases, when considered together, still constitute a “database” as that term is used herein. Thus in FIG. 1A, the databases 140, 150, 160, 170, 180, and 190 can be considered to be a single database. The system can include other databases such as a subject database storing data related to subjects in the area of real space, a cart database storing logs of items or carts of subjects in the area of real space, etc.

Details of the various types of processing engines are presented below. These engines can comprise various devices that implement logic to perform operations to track subjects, detect and process object events and perform other operations related to a cashier-less area of real space. A device (or an engine) described herein can include one or more processors. The ‘processor’ comprises hardware that runs a computer program code. Specifically, the specification teaches that the term ‘processor’ is synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry.

FIG. 1B presents components (such as devices) of the example camera system 114a. Other camera systems (such as 114b and 114n) installed in the area of real space can have similar components or devices. The camera systems 114 can be used for detecting events and identifying items in detected events in the area of real space in an area of real space including a cashier-less checkout system. The camera system 114a can include a camera assembly comprising at least two sensors, such as at least one narrow field of view (NFOV) image sensor and at least one wide field of view (WFOV) image sensor. In one implementation, the camera system can comprise a plurality of NFOV image sensors. Each of the NFOV image sensors can produce raw image data of high-resolution frames of a corresponding field of view in the real space. The one or more WFOV image sensors can produce raw image data of low-resolution frames of a corresponding field of view in the real space. The image sensor assembly can comprise six or more NFOV image sensors. The high-resolution frames can have an image resolution of at least 8,000 pixels by 6,000 pixels. It is understood that NFOV image sensors can capture images at a resolution lower than 8,000 pixels by 6,000 pixels or at a higher resolution than 8,000 pixels by 6,000 pixels. In one implementation, each of the NFOV image sensors is configured to output at least one frame every thirty seconds. It is understood that one or more NFOV image sensors can output more than one image frame per thirty seconds. The low-resolution frames from WFOV image sensor can have an image resolution of at least 3,040 pixels by 3,040 pixels. It is understood that WFOV image sensors can capture images at a resolution lower than 3,040 pixels by 3,040 pixels or at a higher resolution than 3,040 pixels by 3,040 pixels. The sensor assembly can include one or more than one (such as two) WFOV image sensors.

As shown in FIG. 1B, the camera system 114a comprises an event detection device 196 configured to detect (i) a particular event and (ii) a location of the particular event in the area of real space. The event can include at least one of a put event, a take event and a touch event related to an item. The event detection device can receive at least a portion of a sequence of low-resolution frames produced by the WFOV image sensor to detect the event. The event detection device 196 can implement the same logic as implemented by the event detection and classification engine 194.

The camera system 114a comprises a sensor selection device 197 comprising logic to select a particular sensor from a plurality of NFOV sensors in the camera system. The selection can be based on a location of the detected event. The selection of a NFOV allows processing a sequence of the high-resolution frames provided by the NFOV image sensor by matching the location in the area of real space to the corresponding field of view of the NFOV image sensor. The sensor selection device 197 can communicate with camogram generation engine 192 and can access camograms database 180 and maps database 160 when selecting a sensor that includes the location of an event in its field of view. The camera system 114a can also include logic to communicate with other camera systems in the area of real space when selecting a sensor that provides a best view of the item related to an event. In some cases, a sensor from another camera system can provide a better view of the item in the object event. The technology disclosed can select a sensor that provides a good image of the item for item detection and/or item classification.

The camera system 114a comprises an item detection device 198 to identify a particular item in the particular event detected by the event detection device using at least one frame in the selected sequence of high-resolution frames.

The camera system 114a comprises a pose detection device 199 to process image frames from the sequence of low-resolution image frames to determine features of the subjects for identifying and tracking subjects in the area of real space. The pose detection device 199 includes logic to generate poses of subjects by combining various features (such as joints, head, neck, fect, etc.) of the subject. The camera system can include other devices that include logic to support operations of the camera system. For example, the camera system 114a can include a telemetry device (or telemetry agent) 200 to monitor various parameters of the camera system during its operation and generate notifications when one or more parameter values move outside a desired range. The camera system 114a can include other devices as well such as a device to connect the camera system to a management system to update the configuration parameters, access and install operating system and/or firmware updates. The camera system 114a can include devices that include logic to process image frames to detect anomalies in the area of real space, medical emergencies, security threats, products spills, congestions, etc. and generate alerts for management and/or assistants. Such a device can also include logic to determine when a subject needs help in the area of real space and generate a notification or a message for an assistant to respond to the subject or move to the location of the subject to help her.

Referring back to FIG. 1A, for the sake of clarity, only three network nodes 101a, 101b and 101n hosting image recognition engines 112a, 112b, and 112n are shown in the system 100. However, any number of network nodes hosting image recognition engines can be connected to the subject tracking engine 110 through the network(s) 181. In one implementation, the image recognition engines 112a, 112b and 112n can be implemented as part of the respective camera systems 114a, 114b and 114n. In another implementation, a portion of the functionality of the image recognition engines 112a, 112b and 112n can be implemented as part of the respective camera systems 114a, 114b and 114n. Similarly, the image recognition engines 112a, 112b, and 112n, the subject tracking engine 110, the event detection and classification engine 194, the camogram generation engine 192 and/or other processing engines described herein can execute various operations using more than one network node in a distributed architecture. The subject tracking engine 110 can be implemented as part of the camera system 114a by combining image frames from a plurality of camera systems to generate three dimensional scenes. In one implementation, a plurality of WFOV image sensors can be included in a single camera system to generate three dimensional scenes using sequences of images frames from cameras (or sensors) within a same camera system.

The interconnection of the elements of system 100 will now be described with reference to FIG. 1A. Network(s) 181 couples the network nodes 101a, 101b, and 101n, respectively, hosting image recognition engines 112a, 112b, and 112n, the network node 102 hosting the subject tracking engine 110, the network node 104 hosting the event detection and classification engine 194, the network node 106 hosting the camogram generation engine 192, the database 140, the items database 150, the map database 160, the camera placement database 170, the camograms database 180, and the video/image database 190. Camera systems 114 are connected to the subject tracking engine 110, the event detection and classification engine 194, and/or the camogram generation engine 192 through network nodes hosting image recognition engines 112a, 112b, and 112n. In one embodiment, the camera systems 114 are installed in an area of real space, such that sets of camera systems 114 (two or more) with overlapping fields of view are positioned to capture images of an area of real space in the area of real space. Two camera systems 114 can be arranged over a first corridor within the area of real space, two camera systems 114 can be arranged over a second corridor in the area of real space, and three camera systems 114 can be arranged over a third corridor in the area of real space. Camera systems 114 can be installed over open spaces, corridors, and near exits and entrances to the area of real space. In such an embodiment, the camera systems 114 can be configured with the goal that subjects moving in the area of real space are present in the field of view of two or more camera systems 114 at any moment in time.

Camera systems 114 include sensors that can be synchronized in time with other sensors in the same camera system as well as with sensors in other camera systems 114 installed in the area of real space, so that images are captured at the image capture cycles at the same time, or close in time, and at the same image capture rate (or a different capture rate). The sensors and/or cameras can send respective continuous streams of images at a predetermined rate to respective image processing devices including the network nodes 101a, 101b, and 101n hosting image recognition engines 112a-112n. Images captured by sensors or cameras in all the camera systems 114 covering an area of real space at the same time, or close in time, are synchronized in the sense that the synchronized images can be identified in engines 112a, 112b, 112n, 110, 192 and/or 194 as representing different views of subjects having fixed positions in the real space. For example, in one implementation, the WFOV sensors can send image frames at the rates of ten (10) frames per second (fps) to respective network nodes 101a, 101b and 101n hosting image recognition engines 112a-112n. It is understood that WFOV sensors can capture image data at rates greater than ten frames per second or less than ten frames per second. In one implementation, the NFOV sensors can send one image frame per thirty seconds. The NFOV sensors can capture image frames at a rate greater than one frame per thirty seconds or less than one frame per thirty seconds. Each frame has a timestamp, identity of the camera (abbreviated as “camera_id” or a “sensor_id”), and a frame identity (abbreviated as “frame_id”) along with the image data. An image frame can also include a camera system identifier. In some cases, a separate mapping can be maintained to determine the camera system to which a sensor or a camera belongs. As described above other embodiments of the technology disclosed can use different types of sensors such as image sensors, ultrasound sensors, thermal sensors, ultra-wideband, depth sensors, and/or Lidar, etc. Images can be captured by sensors at frame rates greater than 30 frames per second, such as 40 frames per second, 60 frames per second or even at higher image capturing rates, or lower than thirty (30) frames per second, such as ten (10) frames per second, one (1) frame per second, or even at lower image capturing rates. In one implementation, the images are captured at a higher frame rate when an object event such as a put or a take or a touch of an item is detected in the field of view of a sensor. In such an embodiment, when no object event is detected in the field of view of a sensor, the images are captured at a lower frame rate.

In one implementation, the camera systems 114 can be installed overhead and/or at other locations, so that in combination, the fields of view of the cameras encompass an area of real space in which the tracking is to be performed, such as in an area of real space.

In one implementation, each image recognition engine 112a, 112b, and 112n is implemented as a deep learning algorithm such as a convolutional neural network (abbreviated CNN). In such an embodiment, the convolutional neural network (CNN) is trained using a training database. In an embodiment described herein, image recognition of subjects in the area of real space is based on identifying and grouping features of the subjects such as joints, recognizable in the images, where the groups of joints (e.g., a constellation) can be attributed to an individual subject. For this joints-based analysis, the training database has a large collection of images for each of the different types of joints for subjects. In the example embodiment of an area of real space, the subjects are the subjects moving in the corridors between the shelves. In an example embodiment, during training of the convolutional neural network (CNN), the system 100 is referred to as a “training system.” After training the convolutional neural network (CNN) using the training database, the convolutional neural network (CNN) is switched to production mode to process images of subjects in the area of real space in real time.

The technology disclosed is related to camera systems 114 that can be used for tracking objects placed on display structures in the area of real space. The technology disclosed can also track subjects in an area of real space and identify actions of subjects including takes and puts of objects such as objects on object locations such as shelves or other types of display structures. Other types of object events can also be detected such as when a subject touches, rotates and/or moves an item on its location without taking the item. The technology disclosed includes logic to detect what items are positioned on which shelves as this information changes over time. The detection and classification of items is challenging due to subtle variations between items. Additionally, the items are taken and placed on shelves in environments with occlusions that block the view of the cameras. The technology disclosed can reliably detect object events and classify the object events as takes and puts of items on shelves. To support the reliable detection and classification of object events and objects related to object events, the technology disclosed generates and updates camograms of the area of real space.

Camograms can be considered as maps of items placed on object display structures such as shelves, or placed on the floor, etc. Camograms can include images of object display structures with classification of objects positioned on the shelf at their respective locations (e.g., at respective “cells” as described in more detail below). When a shelf is in the field of view of the camera, the system 100 can detect which objects are positioned on that shelf and where the specific objects are positioned on the shelf with a high level of accuracy. The technology disclosed can associate an object taken from the shelf to a subject such as a subject or associate the object to an assistant of the area of real space who is stocking the objects.

The technology disclosed can perform detection and classification of objects. The detection task in the context of a cashier-less area of real space is to identify whether an item is taken from a shelf by a subject such as a subject. In some cases, it is also possible to detect whether an item is placed on a shelf by a subject who can be an assistant to record a stocking event. The classification task is to identify what item was taken from the shelf or placed on the shelf. The event detection and classification engine 194 includes logic to detect object events (such as puts and takes) in the area of real space and classify objects detected in the object event. In one implementation, the event detection and classification engine 194 can be implemented entirely or partially as part of the camera systems 114. The subject tracking engine 110 includes logic to track subjects in the area of real space by processing images captured by sensors positioned in the area of real space.

Camograms can support the detection and classification tasks by identifying the location on the shelf from where an item has been taken from or placed at. The technology disclosed includes systems and methods to generate, update and utilize camograms for detection and classification of items in an area of real space. The technology disclosed includes logic to use camograms for other tasks in a cashier-less area of real space such as detecting size of an object. Updating the camograms (e.g., the map of the area of real space) takes time and processing power. The technology disclosed implements techniques that eliminate unnecessarily updating the camograms (or portions thereof) when inventor items are shifted, rotated, and/or tilted, yet they remain in essentially the same location (e.g., cell). In other words, the system 100 can skip updating the camograms when the objects have moved slightly, but still remain in the same location (or they have moved to another appropriately designated location).

The technology disclosed includes systems and methods to detect changes to portions of camograms and apply updates to only those portions of camograms that have been updated, such as when one or more new items are placed in a shelf or when one or more items have been taken from a shelf. The technology disclosed includes a trigger-based system that can process a signal and/or signals received from sensors in the area of real space to detect changes to a portion or portions of an image of an area of real space (e.g., camograms). The signals can be generated by other processing engines that process the images captured by sensors and output signals indicating a change in a portion of the area of real space. Applying updates to only those portions of camograms in which a change has occurred improves the efficiency of maintaining the camograms and reduces the computational resources required to update camograms over time. In busy areas of real space, the placement of items on shelves can change frequently, therefore a trigger-based system enables real time or near real time updates to camograms. The updated camogram improves operations of an area of real space by reliably detecting which item was taken by a subject and also providing a real time object status to management.

The technology disclosed implements a computer vision-based system that includes a plurality of sensors or cameras having overlapping fields of view. Some difficulties are encountered when identifying objects, as a result of images of objects being captured with steep perspectives and partial occlusions. This can make it difficult to correctly detect or determine sizes of items (e.g., an 8 ounce can of beverage of brand “X” or a 12 ounce can of beverage of brand “X”) as items of the same type (or product) with different sizes can be placed on shelves with no clear indication of sizes on shelves (e.g., the shelf may not be labeled to distinguish between 8 ounce can and 12 ounce can). Current machine vision-based technology has difficulty determining whether a larger or smaller version of the same type of item is placed on the shelf. One reason for this difficulty is due to different distances of various cameras to the object. The image of an object from one camera can appear larger as compared to the image captured from another camera because of different distances of the cameras to the object and also due to their different perspectives. The technology disclosed includes image processing and machine learning techniques that can detect and determine sizes of items of the same product placed in object display structures. This provides an additional input to the item classification model further improving the accuracy of item classification results. Further details of camograms are presented in the following section.

### Camogram

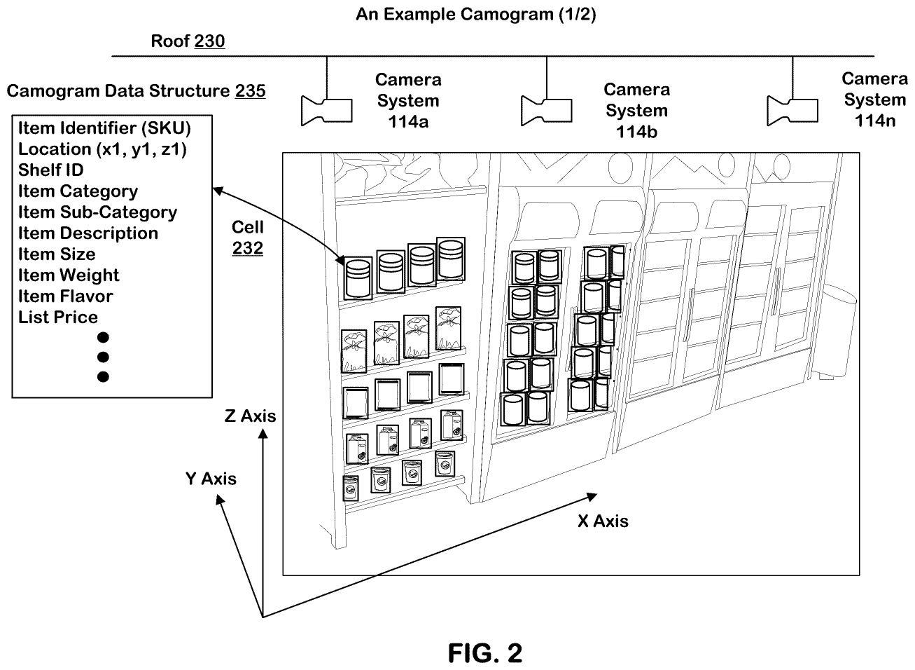

FIG. 2 presents an example camogram superimposed on the shelves or display structures. The camogram can be considered as a map of objects placed in the area of real space. The map includes locations of cells or boxes in the map. The cells or boxes can be arranged in rows and columns. An object is located in the location of a cell in the map. The cell encloses the object. For example, a canned object is located in the location of the cell 232. The cell 232 is shown as enclosing the canned item placed on a top left-most position of the shelf. When a shelf is in the field of view of a camera, the technology disclosed can detect what products are positioned on a shelf and where (location in two-dimensions or 3-dimensions) the specific products are positioned on the shelf with a high level of accuracy. The technology disclosed can associate an item taken from the shelf or placed on a shelf to a subject such as a subject or an assistant, etc.

FIG. 2 shows example display structures in which items are placed on shelves. A plurality of camera systems 114 (such as camera system 114a, camera system 114b, camera system 114n) are positioned on the ceiling or roof 230 and oriented to view the shelves and open spaces in the area of real space. Only three camera systems 114a, 114b and 114n are shown for illustration purposes. The objects positioned in the shelf are identified by the machine vision technology and information of the detected items are stored in camogram data structure 235. The data structure 235 can store information related to objects positioned in one cell (232) or more than one cell. Some example data stored in the camogram data structure is shown in FIG. 2 including item identifier (such as a SKU), location of the item in the area of real space (x1, y1, z1), shelf identifier (shelf ID), item category, item sub-category, item description, item size (such as small, medium, large, etc.), weight of item (such as in grams, lbs., etc.), item volume (such as in ml, etc.) flavor of item, and/or item value, etc. It is understood that additional data related to objects can be stored in the camogram data structure. The camogram data is stored in the camogram database 180. The data in the camogram database can be linked to objects data in the items database 150 using a foreign-key relationship such as item's SKU or any other type of item identifier.

In the example of an area of real space, the subjects move in the corridors and in open spaces. The subjects take items from object locations on shelves in display structures. In one example of display structures, shelves are arranged at different levels (or heights) from the floor and objects are stocked on the shelves. The shelves can be fixed to a wall or placed as freestanding shelves forming corridors in the area of real space. Other examples of display structures include, pegboard shelves, magazine shelves, rotating (e.g., lazy susan type) shelves, warehouse shelves, and/or refrigerated shelving units. In some instances such as in the case of refrigerated shelves, the items in the shelves may be partially or completely occluded by a door at certain points of time. In such cases, the subjects open the door to take an item or place an item on the shelf. The objects can also be stocked in other types of display structures such as stacking wire baskets, dump bins, etc. The subjects can also put items back on the same shelves from where they were taken or on another shelf. In such cases, the camogram may need to be updated to reflect a different item now positioned in a cell which previously referred to another item.

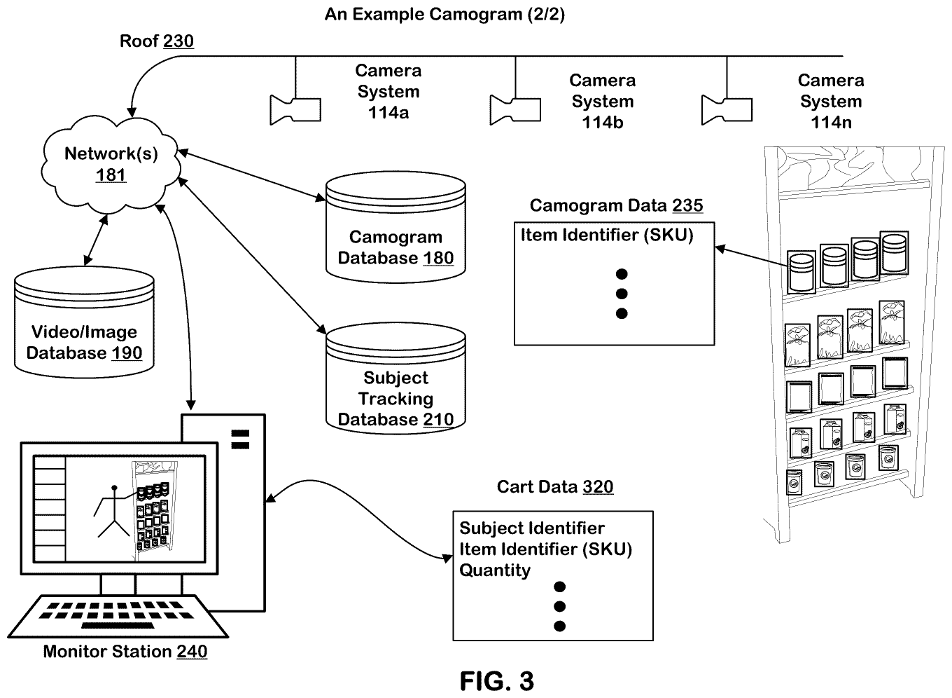

FIG. 3 shows selected components of a system that can be used to generate or update a camogram. The system shown in FIG. 3 includes multiple camera systems 114 positioned over an area of real space. Only three camera systems, 114a, 114b and 114n are shown for illustration purposes. The camera systems (e.g., 114a, 114b and 114n) can be installed at the ceiling or roof 230 and oriented to have shelves and open areas of the real space such as the area of real space in their respective fields of view. The cameras can be connected to a cloud-based storage database system or on-premises database system to store data in the video/image database 190. The system can include a plurality of monitoring systems or monitoring stations 240. The system includes “camera system selection” or “camera/sensor selection” logic that can select camera systems and/or cameras or sensors in a particular camera system to provide a view of the subject moving in the area of real space and taking items from the shelves or placing items on the shelves. The camera selection logic can recommend multiple cameras with a good view of the subject. The monitor can choose one or more cameras to view the subject from the recommended cameras. The monitor can identify takes of items by a subject by using appropriate user interface elements. In one embodiment, the system uses the event detection and classification engine 194 to detect takes of items and puts of items by a subject. The takes and puts of objects can be indicated on the user interface on the monitor stations 240 and the monitor can observe the takes and puts to confirm or reject one or more detected takes and puts. In another embodiment, the system can use trained machine learning models to process images captured by the cameras to detect takes and puts of items by subjects. Trained machine learning models can then be invoked to detect changes to portions of camograms from where items have been taken or where items have been placed. The technology disclosed can then automatically update camograms (e.g., the camogram database 180) representing portions of shelves where changes have been detected.

When an item is detected to be taken by a subject and classified using the event detection and classification engine 194, the item is added to the subject's cart. An example cart data 320 is shown in FIG. 3. The cart (e.g., the cart data structure 320) of a subject can include a subject identifier, an item identifier (such as SKU), a quantity per item and/or other attributes including a total amount to be charged to subject's account for items in her cart. The cart can include additional information such as discounts applied or other information related to the subject's time spent at the area of real space such as timestamp of when the item was taken by the subject. Information such as the camera or sensor identifier, camera system identifier, and frame identifier, which was used to detect and classify the item can be included in the cart or log data structure. The cart data 320 can be stored in a subject database or in a separate cart database that is linked to the subject database using a subject identifier or another unique identifier to track subjects.

### Subject Tracking Engine

The subject tracking engine 110, hosted on the network node 102 receives, in this example, continuous streams of arrays of joints data structures for the subjects from image recognition engines 112a-112n and can retrieve and store information from and to a subject tracking database 210. In one implementation, the subject tracking engine 110 can be implemented as part of the camera system 114a, 114b and 114n. A plurality of camera systems can communicate with each other, directly, or via a server to implement the logic to track subjects in the area of real space. The subject tracking engine 110 processes the arrays of joints data structures identified from the sequences of images received from the cameras at image capture cycles. It then translates the coordinates of the elements in the arrays of joints data structures corresponding to images in different sequences into candidate joints having coordinates in the real space. For each set of synchronized images, the combination of candidate joints identified throughout the real space can be considered, for the purposes of analogy, to be like a galaxy of candidate joints. For each succeeding point in time, movement of the candidate joints is recorded so that the galaxy changes over time. The output of the subject tracking engine 110 is used to locate subjects in the area of real space during identification intervals. One image in each of the plurality of sequences of images, produced by the cameras, is captured in each image capture cycle.

The subject tracking engine 110 uses logic to determine groups or sets of candidate joints having coordinates in real space as subjects in the real space. For the purposes of analogy, each set of candidate points is like a constellation of candidate joints at each point in time. In one embodiment, these constellations of joints are generated per identification interval as representing a located subject. Subjects are located during an identification interval using the constellation of joints. The constellations of candidate joints can move over time. A time sequence analysis of the output of the subject tracking engine 110 over a period of time, such as over multiple temporally ordered identification intervals (or time intervals), identifies movements of subjects in the area of real space. The system can store the subject data including unique identifiers, joints and their locations in the real space in the subject database.

In an example embodiment, the logic to identify sets of candidate joints (i.e., constellations) as representing a located subject comprises heuristic functions is based on physical relationships amongst joints of subjects in real space. These heuristic functions are used to locate sets of candidate joints as subjects. The sets of candidate joints comprise individual candidate joints that have relationships according to the heuristic parameters with other individual candidate joints and subsets of candidate joints in a given set that has been located, or can be located, as an individual subject.

Located subjects in one identification interval can be matched with located subjects in other identification intervals based on location and timing data that can be retrieved from and stored in the subject tracking database 210. An identification interval can include one image for a given timestamp or it can include a plurality of images from a time interval. Located subjects matched this way are referred to herein as tracked subjects, and their location can be tracked in the system as they move about the area of real space across identification intervals. In the system, a list of tracked subjects from each identification interval over some time window can be maintained, including for example by assigning a unique tracking identifier to members of a list of located subjects for each identification interval, or otherwise. Located subjects in a current identification interval are processed to determine whether they correspond to tracked subjects from one or more previous identification intervals. If they are matched, then the location of the tracked subject is updated to the location of the current identification interval. Located subjects not matched with tracked subjects from previous intervals are further processed to determine whether they represent newly arrived subjects, or subjects that had been tracked before, but have been missing from an earlier identification interval.

Tracking all subjects in the area of real space is important for operations in a cashier-less area of real space. For example, if one or more subjects in the area of real space are missed and not tracked by the subject tracking engine 110, it can lead to incorrect logging of items taken by the subject causing errors in generation of an item log (e.g., cart data 320) for this subject. The technology disclosed can implement a subject persistence engine (not illustrated) to find any missing subjects in the area of real space.

In one embodiment, the image analysis is anonymous, i.e., a unique tracking identifier assigned to a subject created through joints analysis does not identify personal identification details (such as names, email addresses, addresses, credit card numbers, bank account numbers, driver's (DL) number, etc.) of any specific subject in the real space. The data stored in the subject's database does not include any personal identification information. Operations of the subject persistence processing engine and the subject tracking engine 110 do not use any personal identification including biometric information associated with the subjects.

In one embodiment, the tracked subjects are identified by linking them to respective “user accounts” containing for example preferred payment methods provided by the subject. When linked to a user account, a tracked subject is characterized herein as an identified subject. Track subjects are linked with items picked up on the area of real space, and linked with a user account, for example, and upon exiting the area of real space, an invoice can be generated and delivered to the identified subject, or a financial transaction executed online to charge the identified subject using the payment method associated with their accounts. The identified subjects can be uniquely identified, for example, by unique account identifiers or subject identifiers, etc. In the example of a cashier-less area of real space, as the subject completes consumption by taking items from the shelves, the system processes payment of items obtained by the subject.

The system can include other processing engines such as an account matching engine (not illustrated) to process signals received from mobile computing devices carried by the subjects to match the identified subjects with their user accounts. The account matching can be performed by identifying locations of mobile devices executing client applications in the area of real space (e.g., the store) and matching locations of mobile devices with locations of subjects, without use of personal identifying biometric information from the images.

Referring to FIG. 1A, the actual communication path to the network node 106 hosting the camogram generation engine 192, the network node 104 hosting the event detection and classification engine 194, the network node 102 hosting the subject tracking engine 110 and the camera systems 114 through the network 181 can be point-to-point over public and/or private networks. The communications can occur over a variety of networks 181, e.g., private networks, VPN, MPLS circuit, or Internet, and can use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), Protobuf, and/or Java Platform Module System. All of the communications can be encrypted. The communication is generally over a network such as a LAN (local area network), WAN (wide area network), telephone network (Public Switched Telephone Network (PSTN), Session Initiation Protocol (SIP), wireless network, point-to-point network, star network, token ring network, hub network, and/or Internet, inclusive of the mobile Internet, via protocols such as EDGE, 3G, 4G LTE, 5G, Wi-Fi, and/or WiMAX. Additionally, a variety of authorization and authentication techniques, such as username/password, Open Authorization (OAuth), Kerberos, SecureID, digital certificates and more, can be used to secure the communications.

The technology disclosed herein can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ and/or PostgreSQL™ compatible relational database implementation and/or a Microsoft SQL Server™ compatible relational database implementation and/or a NoSQL™ non-relational database implementation such as a Vampire™ compatible non-relational database implementation, an Apache Cassandra™ compatible non-relational database implementation, a BigTable™ compatible non-relational database implementation and/or an HBase™ and/or DynamoDB™ compatible non-relational database implementation. In addition, the technology disclosed can be implemented using different programming models like MapReduce™, bulk synchronous programming, MPI primitives, etc. and/or different scalable batch and stream management systems like Apache Storm™, Apache Spark™, Apache Kafka™, Apache Flink™, Truviso™ Amazon Elasticsearch Service™, Amazon Web Services™ (AWS), IBM Info-Sphere™, Borealis™, and/or Yahoo! S4™

### Camera Arrangement

The camera systems 114 are arranged to track subjects (or entities) in a three dimensional (abbreviated as 3D) real space. In the example embodiment of the area of real space, the real space can include the area of the area of real space where items available to subjects are stacked in shelves. A point in the real space can be represented by an (x, y, z) coordinate system. Each point in the area of real space for which the system is deployed is covered by the fields of view of two or more camera systems 114.

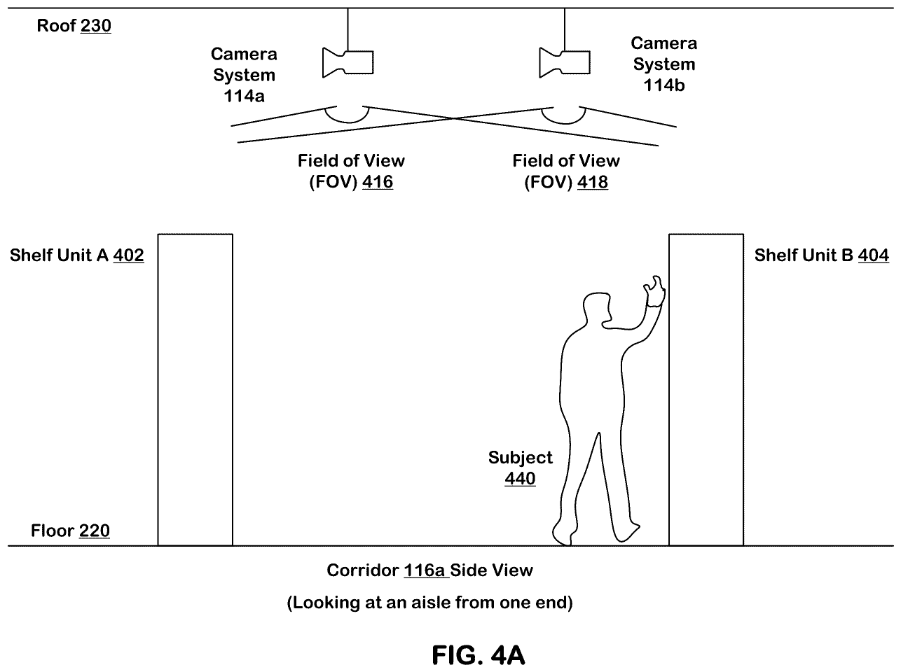

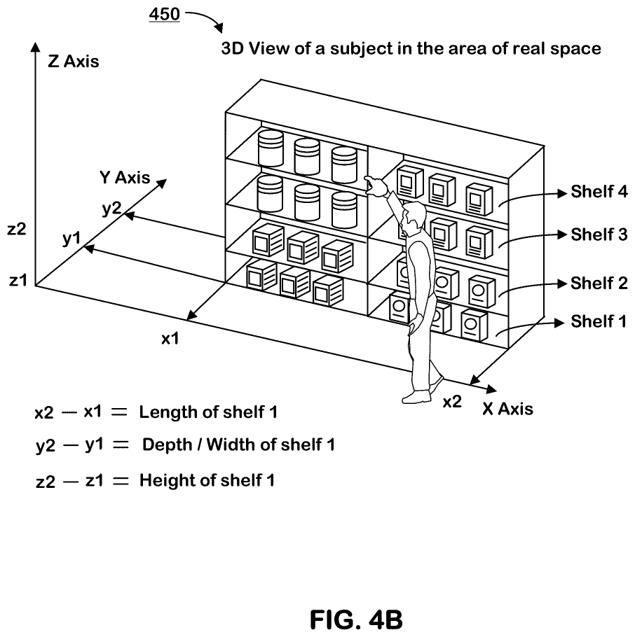

In an area of real space, the shelves and other display structures can be arranged in a variety of manners, such as along the walls of the area of real space, or in rows forming corridors or a combination of the two arrangements. FIG. 4A shows an arrangement of shelf unit A 402 and shelf unit B 404, forming a corridor 116a, viewed from one end of the corridor 116a. Two camera systems, 114a and 114b are positioned over the corridor 116a at a predetermined distance from a ceiling or roof 230 and a floor 220 of the area of real space above the display structures, such as shelf units A 402 and shelf unit B 404. The camera systems 114a and 114b comprise cameras or sensors disposed over and having fields of view encompassing respective parts of the display structures and floor area in the real space. The locations of subjects are represented by their positions in three dimensions of the area of real space. In one implementation, the subjects are represented as a constellation of joints in real space. In this implementation, the positions of the joints in the constellation of joints are used to determine the location of a subject in the area of real space. The camera systems 114 can include Pan-Tilt-Zoom cameras, 360-degree cameras, and/or combinations thereof that can be installed in the real space.

In the example implementation of the area of real space, the real space can include the entire floor 220 in the area of real space. Camera systems 114 are placed and oriented such that areas of the floor 220 and shelves can be seen by at least two cameras. The camera systems 114 also cover floor space in front of the shelve unit A 402 and shelf unit B 404. Camera angles are selected to have both steep perspective, straight down, and angled perspectives that give more full body images of the subjects (e.g., patrons). In one example embodiment, the camera systems 114 are configured at an eight (8) foot height or higher throughout the area of real space. In one embodiment, the area of real space includes one or more designated unmonitored locations such as restrooms.

Entrances and exits for the area of real space, which act as sources and sinks of subjects in the subject tracking engine 110, are stored in the area of real space map database 160. Also, designated unmonitored locations are not in the field of view of camera systems 114, which can represent areas in which tracked subjects may enter, but must return into the area being tracked after some time, such as a restroom. The locations of the designated unmonitored locations are stored in the map database 160. The locations can include the positions in the real space defining a boundary of the designated unmonitored location and can also include location of one or more entrances or exits to the designated unmonitored location.

### Three-Dimensional Scene Generation

In FIG. 4A, a subject 440 is standing by a display structure shelf unit B 404, with one hand positioned close to a shelf (not visible) in the shelf unit B 404. FIG. 4B is a perspective view of the shelf unit B 404 with four shelves, shelf 1, shelf 2, shelf 3, and shelf 4 positioned at different levels from the floor. The objects are stocked on the shelves.

A location in the real space is represented as a (x, y, z) point of the real space coordinate system. “x” and “y” represent positions on a two-dimensional (2D) plane which can be the floor 220 of the area of real space. The value “z” is the height of the point above the 2D plane at floor 220 in one configuration. The system combines 2D images from two or more cameras to generate the three-dimensional positions of joints in the area of real space. This section presents a description of the process to generate 3D coordinates of joints. The process is also referred to as 3D scene generation.

Before using the system 100 in a training or inference mode to track the objects, two types of camera calibrations: internal and external, are performed. In internal calibration, the internal parameters of sensors or cameras in camera systems 114 are calibrated. Examples of internal camera parameters include focal length, principal point, skew, fisheye coefficients, etc. A variety of techniques for internal camera calibration can be used. One such technique is presented by Zhang in “A flexible new technique for camera calibration” published in IEEE Transactions on Pattern Analysis and Machine Intelligence, Volume 22, No. 11, November 2000.

In external calibration, the external camera parameters are calibrated in order to generate mapping parameters for translating the 2D image data into 3D coordinates in real space. In one embodiment, one subject (also referred to as a multi-joint subject), such as a person, is introduced into the real space. The subject moves through the real space on a path that passes through the field of view of each of the cameras or the sensor in camera systems 114. At any given point in the real space, the subject is present in the fields of view of at least two cameras forming a 3D scene. The two cameras, however, have a different view of the same 3D scene in their respective two-dimensional (2D) image planes. A feature in the 3D scene such as a left-wrist of the subject is viewed by two cameras at different positions in their respective 2D image planes.

A point correspondence is established between every pair of cameras with overlapping fields of view for a given scene. Since each camera 114 has a different view of the same 3D scene, a point correspondence is determined using two pixel locations (one location from each camera with overlapping field of view) that represent the projection of the same point in the 3D scene. Many point correspondences are identified for each 3D scene using the results of the image recognition engines 112a to 112n for the purposes of the external calibration. The image recognition engines 112a to 112n identify the position of a joint as (x, y) coordinates, such as row and column numbers, of pixels in the 2D image space of respective cameras or sensors in camera systems 114. In one embodiment, a joint is one of 19 different types of joints of the subject. As the subject moves through the fields of view of different cameras, the subject tracking engine 110 receives (x, y) coordinates of each of the 19 different types of joints of the subject used for the calibration from camera systems 114 per image.

For example, consider an image from a camera A and an image from a camera B both taken at the same moment in time and with overlapping fields of view. There are pixels in an image from camera A that correspond to pixels in a synchronized image from camera B. Consider that there is a specific point of some object or surface in view of both camera A and camera B and that point is captured in a pixel of both image frames. In external camera calibration, a multitude of such points are identified and referred to as corresponding points. Since there is one subject in the field of view of camera A and camera B during calibration, key joints of this subject are identified, for example, the center of left wrist. If these key joints are visible in image frames from both camera A and camera B, then it is assumed that these represent corresponding points. This process is repeated for many image frames to build up a large collection of corresponding points for all pairs of cameras with overlapping fields of view. In one embodiment, images are streamed off of all cameras at a rate of 30 FPS (frames per second) or more or less and a suitable resolution and aspect ratio, such as 720×720 pixels, but can be greater or smaller and with a different ratio such as 1:1, 3:4, 16:9, 9:16, or any other aspect ratio, in full RGB (red, green, and blue) color or in other color and/or non-color schemes. These images may be in the form of one-dimensional arrays (also referred to as flat arrays).

The large number of images collected above for a subject is used to determine corresponding points between cameras with overlapping fields of view. Consider two cameras A and B with overlapping fields of view. The plane passing through camera centers of cameras A and B and the joint location (also referred to as feature point) in the 3D scene is called the “epipolar plane”. The intersection of the epipolar plane with the 2D image planes of the cameras A and B defines the “epipolar line”. Given these corresponding points, a transformation is determined that can accurately map a corresponding point from camera A to an epipolar line in camera B's field of view that is guaranteed to intersect the corresponding point in the image frame of camera B. Using the image frames collected above for a subject, the transformation is generated. It is known in the art that this transformation is non-linear. The general form is furthermore known to require compensation for the radial distortion of each camera's lens, as well as the non-linear coordinate transformation moving to and from the projected space. In external camera calibration, an approximation to the ideal non-linear transformation is determined by solving a non-linear optimization problem. This non-linear optimization function is used by the subject tracking engine 110 to identify the same joints in outputs (arrays of joint data structures) of different image recognition engines 112a to 112n, processing images of sensors or cameras in camera systems 114 with overlapping fields of view. The results of the internal and external camera calibration are stored in a calibration database.

A variety of techniques for determining the relative positions of the points in images captured by sensors or cameras in camera systems 114 in the real space can be used. For example, Longuet-Higgins published, “A computer algorithm for reconstructing a scene from two projections” in Nature, Volume 293, 10 Sep. 1981. This paper presents computing a three-dimensional structure of a scene from a correlated pair of perspective projections when spatial relationship between the two projections is unknown. Longuet-Higgins paper presents a technique to determine the position of each camera in the real space with respect to other cameras. Additionally, their technique allows triangulation of a subject in the real space, identifying the value of the z-coordinate (height from the floor) using images from camera systems 114 with overlapping fields of view. An arbitrary point in the real space, for example, the end of a shelf unit in one corner of the real space, is designated as a (0, 0, 0) point on the (x, y, z) coordinate system of the real space. The technology disclosed can use the external calibration parameters of two cameras with overlapping fields of view to determine a two-dimensional plane on which an object is positioned in the area of real space. An image captured by one of the camera systems 114 can then be warped and re-oriented along the determined two-dimensional plane for determining the size of the object. Details of the item size detection process are presented later in this text.

In an embodiment of the technology disclosed, the parameters of the external calibration can be stored in two data structures. The first data structure stores intrinsic parameters. The intrinsic parameters represent a projective transformation from the 3D coordinates into 2D image coordinates. The first data structure contains intrinsic parameters per camera 114 as shown below. The data values are all numeric floating point numbers. This data structure stores a 3×3 intrinsic matrix, represented as “K” and distortion coefficients. The distortion coefficients include six radial distortion coefficients and two tangential distortion coefficients. Radial distortion occurs when light rays bend more near the edges of a lens than they do at its optical center. Tangential distortion occurs when the lens and the image plane are not parallel. The following data structure shows values for the first camera only. Similar data is stored for all the camera systems 114.

```
{
  1: {
    K: [[x, x, x], [x, x, x], [x, x, x]],
    distortion_coefficients: [x, x, x, x, x, x, x, x]
  },
}
```

The second data structure stores per pair of cameras or sensors (in a same camera system or across different camera systems): a 3×3 fundamental matrix (F), a 3×3 essential matrix the, a 3×4 projection matrix (P), a 3×3 rotation matrix (R) and a 3×1 translation vector (t). This data is used to convert points in one camera's reference frame to another camera's reference frame. For each pair of cameras, eight homography coefficients are also stored to map the plane of the floor 220 from one camera to another. A fundamental matrix is a relationship between two images of the same scene that constrains where the projection of points from the scene can occur in both images. Essential matrix is also a relationship between two images of the same scene with the condition that the cameras are calibrated. The projection matrix gives a vector space projection from 3D real space to a subspace. The rotation matrix is used to perform a rotation in Euclidean space. Translation vector “t” represents a geometric transformation that moves every point of a figure or a space by the same distance in a given direction. The homography_floor_coefficients are used to combine images of features of subjects on the floor 220 viewed by cameras with overlapping fields of views. The second data structure is shown below. Similar data is stored for all pairs of cameras. As indicated previously, the x's represents numeric floating point numbers.

```
{
  1: {
    2: {
      F: [[x, x, x], [x, x, x], [x, x, x]],
      E: [[x, x, x], [x, x, x], [x, x, x]],
      P: [[x, x, x, x], [x, x, x, x], [x, x, x, x]],
      R: [[x, x, x], [x, x, x], [x, x, x]],
      t: [x, x, x],
      homography_floor_coefficients: [x, x, x, x, x, x, x, x]
    }
  },
  .......
}
```

Two-dimensional and Three-dimensional Maps

An objects location, such as a shelf, in an area of real space can be identified by a unique identifier in the map database 160 (e.g., shelf_id). Similarly, an area of real space can also be identified by a unique identifier (e.g., id) in the map database 160. Two dimensional (2D) and three dimensional (3D) maps stored in the map database 160 can identify locations in the area of real space along the respective coordinates. For example, in a 2D map, the locations in the maps define two dimensional regions on the plane formed perpendicular to the floor 220 i.e., XZ plane as shown in FIG. 4B. The map can define an area for object locations where objects are positioned. In FIG. 4B, a 2D location of the shelf unit can be represented by four coordinate positions (x1, y1), (x1, y2), (x2, y2), and (x2, y1). These coordinate positions define a 2D region on the floor 220 where the shelf is located. Similar 2D areas are defined for all display structure locations, entrances, exits, and designated unmonitored locations in the area of real space. This information is stored in the map database 160.

In a 3D map, the locations in the map define three dimensional regions in the 3D real space defined by X, Y, and Z coordinates. The map defines a volume for object locations where objects are positioned. In FIG. 4B, a 3D view 450 of shelf 1 in the shelf unit shows a volume formed by eight coordinate positions (x1, y1, z1), (x1, y1, z2), (x1, y2, z1), (x1, y2, z2), (x2, y1, z1), (x2, y1, z2), (x2, y2, z1), (x2, y2, z2) defining a 3D region in which objects are positioned on the shelf 1. Similar 3D regions are defined for object locations in all shelf units in the area of real space and stored as a 3D map of the real space in the map database 160. The coordinate positions along the three axes can be used to calculate length, depth and height of the object locations as shown in FIG. 4B.

In one embodiment, the map identifies a configuration of units of volume which correlate with portions of object locations on the display structures in the area of real space. Each portion is defined by starting and ending positions along the three axes of the real space. Like 2D maps, the 3D maps can also store locations of all display structure locations, entrances, exits and designated unmonitored locations in the area of real space.

The items in an area of real space are arranged in some embodiments according to a planogram which identifies the object locations (such as shelves) on which a particular item is planned to be placed. For example, as shown in FIG. 4B, a left half portion of shelf 3 and shelf 4 are designated for an item (which is stocked in the form of cans).

### Joints Data Structure

The technology disclosed tracks subjects in the area of real space using machine learning models combined with heuristics that generate a skeleton of a subject by connecting the joints of a subject. The position of the subject is updated as the subject moves in the area of real space and performs actions such as puts and takes of objects. The image recognition engines 112a-112n receive the sequences of images from camera systems 114 and process images to generate corresponding arrays of joints data structures. The system includes processing logic that uses the sequences of images produced by the plurality of camera to track locations of a plurality of subjects (in the area of real space) in the area of real space. In one embodiment, the image recognition engines 112a-112n identify one of the 19 possible joints of a subject at each element of the image, usable to identify subjects in the area who may be moving in the area of real space, standing and looking at an object, or taking and putting objects. The possible joints can be grouped in two categories: foot joints and non-foot joints. The 19th type of joint classification is for all non-joint features of the subject (i.e., elements of the image not classified as a joint). In other embodiments, the image recognition engine may be configured to identify the locations of hands specifically. Also, other techniques, such as a user check-in procedure, may be deployed for the purposes of identifying the subjects and linking the subjects with detected locations of their hands as they move throughout the area of real space. However, note that the subjects identified in the area of real space are anonymous. The subject identifiers assigned to the subjects that are identified in the area of real space are not linked to real world identities of the subjects. The technology disclosed does not store any facial images or other facial or biometric features and therefore, the subjects are anonymously tracked in the area of real space. Examples of joint types that can be used to track subjects in the area of real space are presented below:

Foot Joints:
Ankle joint (left and right)

Non-foot Joints:
Neck
Nose
Eyes (left and right)
Ears (left and right)
Shoulders (left and right)
Elbows (left and right)
Wrists (left and right)
Hip (left and right)
Knees (left and right)

Not a joint

An array of joints data structures (e.g., a data structure that stores an array of joint data) for a particular image classifies elements of the particular image by joint type, time of the particular image, and/or the coordinates of the elements in the particular image. The type of joints can include all of the above-mentioned types of joints, as well as any other physiological location on the subject that is identifiable. In one embodiment, the image recognition engines 112a-112n are convolutional neural networks (CNN), the joint type is one of the 19 types of joints of the subjects, the time of the particular image is the timestamp of the image generated by the source camera (or sensor) for the particular image, and the coordinates (x, y) identify the position of the element on a 2D image plane.

The output of the convolutional neural network (CNN) is a matrix of confidence arrays for each image per camera. The matrix of confidence arrays is transformed into an array of joints data structures. A joints data structure is used to store the information of each joint. The joints data structure identifies x and y positions of the element in the particular image in the 2D image space of the camera from which the image is received. A joint number identifies the type of joint identified. For example, in one embodiment, the values range from 1 to 19. A value of 1 indicates that the joint is a left ankle, a value of 2 indicates the joint is a right ankle and so on. The type of joint is selected using the confidence array for that element in the output matrix of convolutional neural network (CNN). For example, in one embodiment, if the value corresponding to the left-ankle joint is highest in the confidence array for that image element, then the value of the joint number is “1”.

A confidence number indicates the degree of confidence of the convolutional neural network (CNN) in detecting that joint. If the value of confidence number is high, it means the convolutional neural network (CNN) is confident in its detection. An integer-Id is assigned to the joints data structure to uniquely identify it. Following the above mapping, the output matrix of confidence arrays per image is converted into an array of joints data structures for each image. In one embodiment, the joints analysis includes performing a combination of k-nearest neighbors, mixture of Gaussians, and various image morphology transformations on each input image. The result comprises arrays of joints data structures which can be stored in the form of a bit mask in a ring buffer that maps image numbers to bit masks at each moment in time.

### Subject Tracking Using Joints Data Structure

The subject tracking engine 110 is configured to receive arrays of joints data structures generated by the image recognition engines 112a-112n corresponding to images in sequences of images from camera systems 114 having overlapping fields of view. The arrays of joints data structures per image are sent by image recognition engines 112a-112n to the subject tracking engine 110 via the network(s) 181. The subject tracking engine 110 translates the coordinates of the elements in the arrays of joints data structures from 2D image space corresponding to images in different sequences into candidate joints having coordinates in the 3D real space. A location in the real space is covered by the field of views of two or more cameras. The subject tracking engine 110 comprises logic to determine sets of candidate joints having coordinates in real space (constellations of joints) as located subjects in the real space. In one embodiment, the subject tracking engine 110 accumulates arrays of joints data structures from the image recognition engines for all the cameras at a given moment in time and stores this information as a dictionary in the subject tracking database 210, to be used for identifying a constellation of candidate joints corresponding to located subjects. The dictionary can be arranged in the form of key-value pairs, where keys are camera ids and values are arrays of joints data structures from the camera. In such an embodiment, this dictionary is used in heuristics-based analysis to determine candidate joints and for assignment of joints to located subjects. In such an embodiment, a high-level input, processing and output of the subject tracking engine 110 is illustrated in Table 1 (see below). Details of the logic applied by the subject tracking engine 110 to create subjects by combining candidate joints and track movement of subjects in the area of real space are presented in U.S. patent application Ser. No. 15/847,796, titled, “Subject Identification and Tracking Using Image Recognition Engine,” filed on 19 Dec. 2017, now issued as U.S. Pat. No. 10,055,853, which is fully incorporated into this application by reference.

TABLE 1
Inputs, processing and outputs from subject
tracking engine 110 in an example embodiment.

| Inputs | Processing | Output |
|---|---|---|
| Arrays of joints data | Create joints dictionary | List of located subjects |
| structures per image | Reproject joint positions | located in the real space |
| and for each joints | in the fields of view of | at a moment in time |
| data structure | cameras with overlapping | corresponding to an |
| Unique ID | fields of view to | identification interval |
| Confidence number | candidate joints | |
| Joint number | | |
| 2D (x, y) position in | | |
| image space | | |

### Subject Data Structure

The subject tracking engine 110 uses heuristics to connect joints identified by the image recognition engines 112a-112n to locate subjects in the area of real space. In doing so, the subject tracking engine 110, at each identification interval, creates new located subjects for tracking in the area of real space and updates the locations of existing tracked subjects matched to located subjects by updating their respective joint locations. The subject tracking engine 110 can use triangulation techniques to project the locations of joints from 2D image space coordinates (x, y) to 3D real space coordinates (x, y, z). A subject data structure can be used to store an identified subject. The subject data structure stores the subject related data as a key-value dictionary. The key is a “frame_id” and the value is another key-value dictionary where key is the camera_id (e.g., of a WFOV camera in a camera system) and value is a list of 18 joints (of the subject) with their locations in the real space. The subject data is stored in a subject database. A subject is assigned a unique identifier that is used to access the subject's data in the subject database.

In one embodiment, the system identifies joints of a subject and creates a skeleton (or constellation) of the subject. The skeleton is projected into the real space indicating the position and orientation of the subject in the real space. This is also referred to as “pose estimation” in the field of machine vision. In one embodiment, the system displays orientations and positions of subjects in the real space on a graphical user interface (GUI). In one embodiment, the subject identification and image analysis are anonymous, i.e., a unique identifier assigned to a subject created through joints analysis does not identify personal identification information of the subject as described above.

For this embodiment, the joints constellation of a subject, produced by time sequence analysis of the joints data structures, can be used to locate the hand of the subject. For example, the location of a wrist joint alone, or a location based on a projection of a combination of a wrist joint with an elbow joint, can be used to identify the location of hand of a subject.

### Subject Accounts

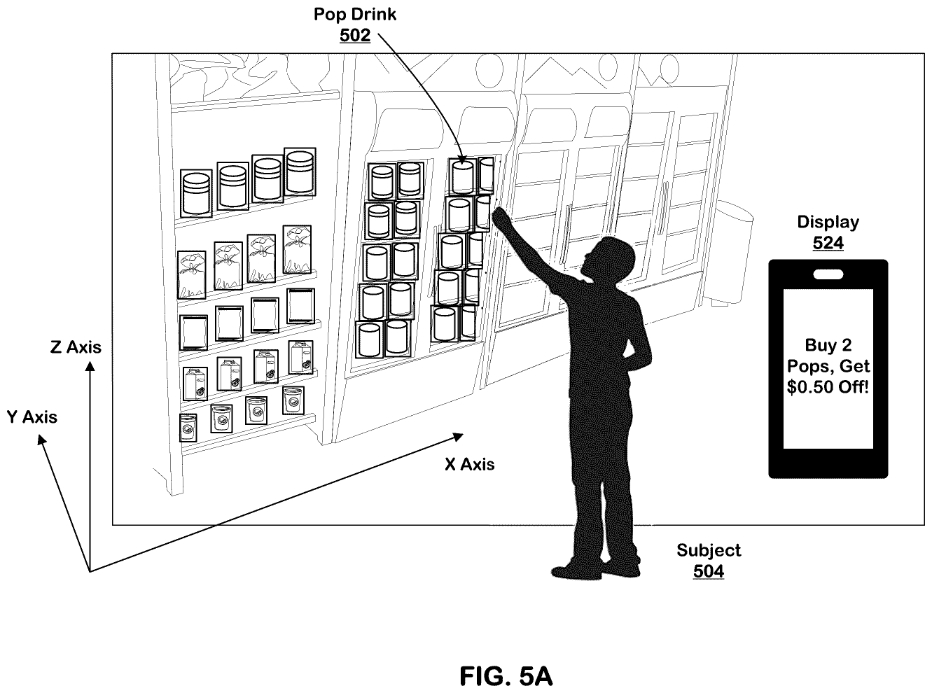

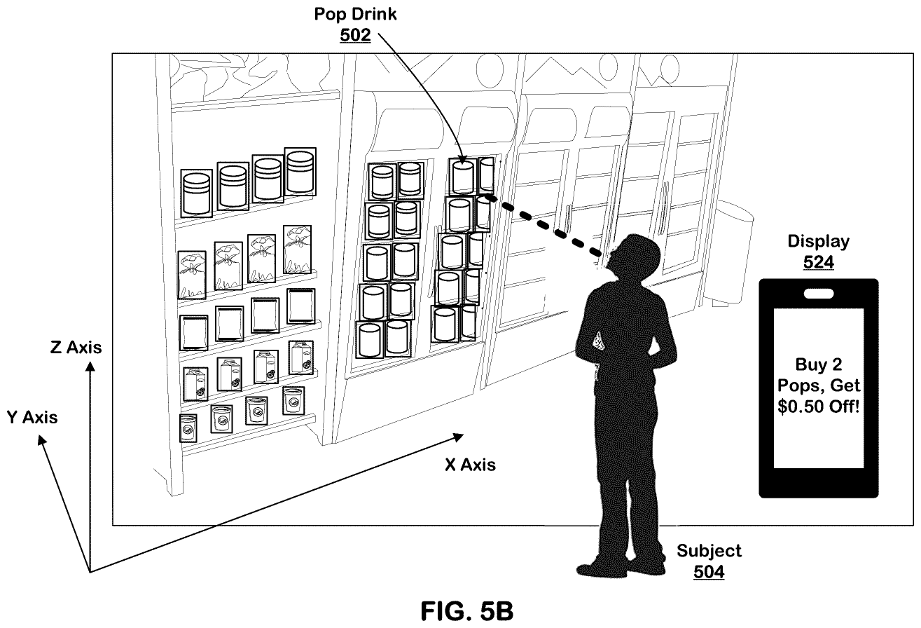

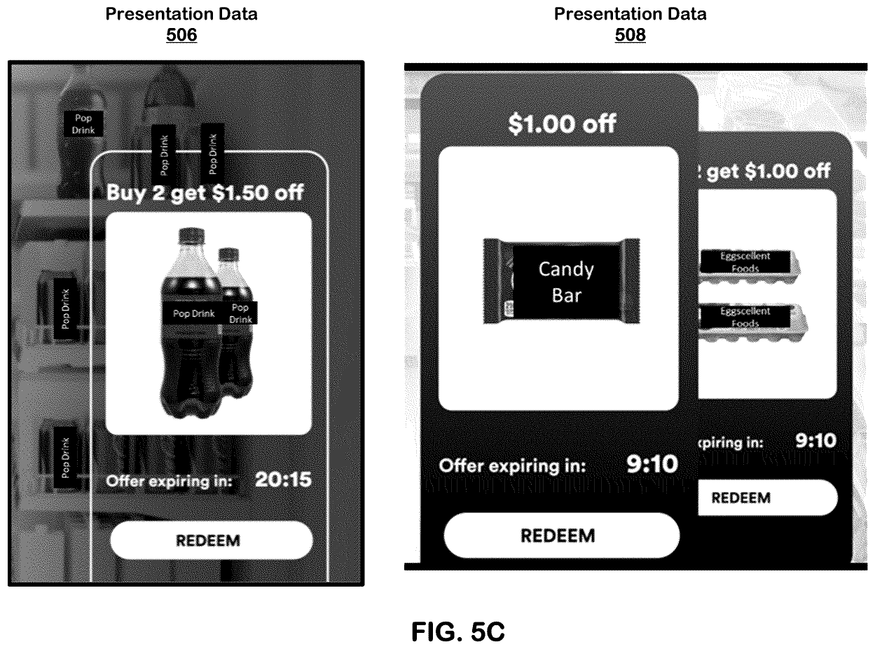

In certain implementations of the disclosed system, the tracked subjects can be identified by linking them to respective “user accounts” containing for example preferred payment method provided by the subject. When linked to a user account, a tracked subject is characterized herein as an identified subject. Track subjects are linked with items picked up on the area of real space, and linked with a user account, for example, and upon exiting the area of real space, an invoice can be generated and delivered to the identified subject, or a financial transaction executed online to charge the identified subject using the payment method associated to their accounts. The identified subjects can be uniquely identified, for example, by unique account identifiers or subject identifiers, etc. In the example of a cashier-less area of real space, as the subject completes consumption by taking items from the shelves, the system processes payment of items bought by the subject. The subject can access their user account and associated information, such as their current cart and digital receipts for former trips, within a client application operating on a user device (e.g., a smart phone). A plurality of data features related to the subject may be associated with the user account, such as a history, demographic information like age and gender, and/or interactions with a program associated with the subject. The subject may interact with their client application at various points in a trip, such as checking in to the area of real space to begin consumption, monitoring their digital cart, viewing their digital receipt after consumption/obtaining has been completed, and various informational materials. For example, the subject may use the client application to observe the area of real space-related information (e.g., viewing maps or looking up an object to obtain its location within the area of real space), presentation data/information (e.g., subject information and benefits, or presentation data provided by the proprietor area of real space or a specific manufacturer/distributor), and so on. The subject may receive a push notification in certain scenarios providing presentation data related to their recent behavior, such as a manufacturer's presentation data for a specific brand of pasta while the subject is looking at the various brands of pasta available on a corridor shelf. Real-time presentation data is discussed in further detail with reference to FIGS. 5A, 5B, and 5C below.

Although the disclosed real-time presentation data can be linked to user accounts, such as a card that identifies the account or account information related to a subject or cashier-less system, many implementations of the technology disclosed maintain anonymity of all subjects in the area of real space during subject tracking. Tracking of subject location, interactions, impressions, and behavior can be performed without collecting any images, biometric data, or any other form of personal identifier or personal data from the subject. While some implementations can include optionally augmenting the subject tracking with user accounts or demographic information, said optional features are not necessary. As such, certain implementations may comprise a hybrid model in which subject tracking is performed anonymously as a default but individuals can “opt-in”/consent to providing additional information. In one example, a subject can opt-in by linking their subject card (or similar subject account) to the real-time presentation data to improve the personalization of the presentation data generated for the subject based on additional data provided by the user account or smart phone application. In another example, a subject can opt-in by linking their cell phone, smart watch, VR/AR wearable (e.g., Google Glasses and Apple Vision Pro) or other technology with location and/or velocity tracking capability in order to improve the personalization of presentation data based on additional subject tracking behavior, with or without providing additional user account data. In another example, a subject can opt-in by answering surveys while in the area of real space (e.g., using a touch-screen display or via interaction with an assistant) in order to personalize their presentation data for the current trip without providing any additional personal data or linking any accounts. In some implementations, once a user has engaged with a display (e.g., a touch screen interface) to accept presentation data, the user will be presented with the option to answer additional survey questions. The additional survey questions could be related to the user's perception of the presentation data, their perception of certain products or brands, or the objective of their current trip, for example. Users may be provided with additional presentation data for responding to the optional survey questions (e.g., original presentation data for 10% off being upgraded to 15% off, or second presentation data for a particular brand associated with the optional survey).

In some implementations, personalization of in area of real space presentation data is partially dependent on demographic data. In one example implementation, demographic data is received from a user's linked account or survey response. In another example implementation, demographic data is predicted using the computer vision system and inference software (e.g., predicting age group or gender of a particular subject, or inferring that a subject is a parent when that subject is accompanied by a child).

### Subject Location Tracking

The disclosed system can further logic for identifying subjects by matching tracked subjects with user accounts in certain implementations. The subject tracking and identification process can use radio signals emitted by the mobile devices indicating location of the mobile devices. In one example implementation, the system accepts login communication from a client application on a mobile computing device link an authenticated user account to the mobile computing device. Next, the system receives service location information from the mobile devices in the area of real space at regular intervals. In one implementation, latitude and longitude coordinates of the mobile computing device emitted from a global positioning system (GPS) receiver of the mobile computing device are used by the system to determine the location. In one implementation, the service location of the mobile computing device obtained from GPS coordinates has an accuracy between 1 to 3 meters. In another implementation, the service location of a mobile computing device obtained from GPS coordinates has an accuracy between 1 to 5 meters.

Other techniques can be used in combination with the above technique or independently to determine the service location of the mobile computing device. Examples of such techniques include using signal strengths from different wireless access points (WAP) as an indication of how far the mobile computing device is from respective access points. The system then uses known locations of wireless access points (WAP) to triangulate and determine the position of the mobile computing device in the area of real space. Other types of signals (such as Bluetooth, ultra-wideband, and ZigBee) emitted by the mobile computing devices can also be used to determine a service location of the mobile computing device.

Many implementations of the technology disclosed include further configuring the system to identify the location of a subject using ultra-wideband (UWB) communication. The usage of UWB-based techniques for matching identified subjects with subject accounts can rely on UWB signals emitted by, for example, the mobile devices indicating the service location. In one example implementation, the UWB-based location tracking process includes the system accepting login communication from a client application on a mobile computing device to link an authenticated subject account to the mobile computing device, followed by the system receiving service location information from the mobile computer device in the area of real space at regular intervals. The latitude and longitude coordinates of the mobile computing device emitted from a global positioning system (GPS) receiver of the mobile computing device can also be used in combination with the UWB signals emitted by the mobile computing device to determine the location of the mobile computing device. Other techniques (e.g., Bluetooth, 5G, and ZigBec) can also be used in combination with the UWB-based technique, or independently, to determine the service location of the mobile computing device.

UWB communication protocol is an IEEE 802.15.4a/z standard technology optimized for secure microlocation-based applications. UWB enabled distance and location can be calculated on a centimeter-scale by measuring the time it takes radio signals to travel between devices. Additionally, the wide bandwidth of UWB further enables robust and an immune resistance to various alternative forms of signal interference and UWB protocols are capable of supporting a large number of connected devices. Hence, the implementation of an UWB-based technique for matching identified subjects with subject accounts can be advantageous for tracking a plurality of subject devices within a crowded space or separate, adjacent spaces. In particular, tracking of a subject that is located near the boundary separating two adjacent tracking spaces (e.g., the entrance region of the area of real space located directly next to a fueling station) can be performed with higher accuracy when employing UWB-based location tracking, particularly when the area is crowded by many subjects.

Unlike other radio signal technologies, UWB does not use amplitude or frequency modulation to encode the information that signals carry; rather, UWB uses short sequences of narrow pulses (e.g., via binary phase-shift keying (BPSK) and/or burst position modulation (BPM)) to encode data. Techniques such as BPSK and/or BPM enable UWB-based location tracking methods to calculate precise distance estimates in enclosed environments in which multipath reflections are widespread. In practice, this allows UWB to be robust to environments comprising multiple physical barriers or partitions. For areas of real space that are divided into tracking areas corresponding to physical barriers, such as separate corridors, an outdoor fueling station separate from an enclosed area of real space, or an isolated walk-in cooler, it is advantageous to use a location tracking technique that does not lose accuracy as a result of these physical barriers. Accordingly, location tracking techniques that leverage UWB protocols are well-suited to track subject behavior within an area of real space in order to provide personalized real-time presentation data to the subject via their user account.

### Realtime and Personalized Presentation Data

Many traditional approaches to providing personalized presentation data involve the presentation of presentation data to a subject based on the subject's consumption/obtaining history or demographic data. However, use of these data types exclusively to predict behavior may illicit undesirable reactions in subjects ranging from annoyance to distress. In one example, a subject who has repeatedly obtained pastries or candy from an area of real space in the past may be provided a discount on other sugary products via their user account. If the subject has recently decided to cut processed sugars out of their diet, a notification providing discounts on sugary products may cause a negative experience for the subject. In another example, personalized presentation data that rely heavily on demographics data run the risk of providing discriminatory or biased presentation data to subjects, intentionally or inadvertently (e.g., presentation data that relies on gender stereotypes to target a consumer audience). In yet another example, such presentation data tactics may illicit severely negative reactions from consumers who have experienced recent life events that cannot be properly inferred from user account data, such as discounts on pet food to subjects who recently lost their pet.

The technology disclosed provides a solution to the problem of potentially harmful personalized presentation data by augmenting personalized retailing tactics with more accurate and more relevant subject presentation data. Accordingly, some implementations involve the personalization and presentation of presentation data that are more closely related to the true habits of a subject and less dependent on predicted habits. One disclosed method comprises identifying objects in an area of real space, identifying subject data about a detected subject, and identifying connections between the subject data and one or more particular identified objects in the area of real space. The identified objects, identified subject data, and/or identified connections between the objects and subject data can be leveraged to calibrate presentation data in the form of presentation data. The disclosed method further comprises triggering presentation of this calibrated presentation data to the subject. Location tracking techniques, such as UWB, provide fine-grained location data that can be used to provide accurate data reflecting the subject location within the area of real space. In some implementations, location tracking is combined with orientation data like pose, dwell, or directional gaze detection to further improve the accuracy of subject behavior tracking.

### Directional Gaze Detection

In one implementation, the processing system includes logic that calculates distances of the identified subject from items having locations matching the identified gaze directions and stores the calculated distances. The system includes logic that determines lengths of time for which the subject maintains respective gaze directions and stores the lengths of times. The system includes logic that stores information including subject identifiers and item identifiers for the identified gaze directions.

In one implementation, the system includes logic that uses sequences of frames in a plurality of sequences of frames to identify locations of the identified subject and gaze directions. The system includes image recognition engines which process the sequences of frames to generate corresponding arrays of joint data structures. The image recognition engines identify sets of joints as subjects in the real space. The system includes logic that uses joints in the set of joints to determine the gaze directions of the subject.

In one implementation, the system that uses sequences of frames in a plurality of sequences of frames to identify locations of an identified subject and gaze directions of the identified subject further includes the logic that defines gaze directions as planes orthogonal to a floor in the area of real space. The plane includes a vector corresponding to the gaze direction of the identified subject. In such an implementation, the logic that identifies items in the area of real space matching the identified gaze directions of the subject identifies items mapped to object locations intersected by the plane. In one implementation, the plane orthogonal to the floor includes a plurality of vectors respectively positioned at increasing distance from the floor.

In some implementations, a visual engagement distribution (also referred to synonymously as a “visual association distribution”) is tracked for a subject in order to identify regions of high interest (based on increased visual engagement for said regions) and peripheral regions, thereby weighting visual engagement areas as a signal of subject intent. In one implementation, weighted distributions are further leveraged to generate a visual engagement score that quantifies a subject's interest in the particular objects within a particular region, relative to a pre-defined threshold or relative to other regions. Visual engagement can be tracked by the subject's head orientation alone, or by further integrating facial expression detection, retinal tracking, integration with AR products like camera-enabled glasses worn by subjects, and so on. In some implementations, a subject's visual engagement is measured to determine information about a subject's interest in different products and/or how engaging a particular product is based on a frequency or nature of subject engagement with the product. In other implementations, visual association fields are tracked to more generally collect information about the visual interactions a subject has with their environment, which may include visual engagement as well as other data. For example, the amount of visual gaze movement, variation in gaze direction, and how quickly a detected subject's gaze shifts direction can be useful indicators of visual associations to infer subject intent and/or sentiment.

The system can include display structures in the area of real space. The display structures comprise object locations matched with cells in the area of real space. The mapping of object locations with cells in the area of real space is stored in a database. In one implementation, this is referred to as a maps database. The database identifies object locations of items in the area of real space with cells in the area of real space.

In one implementation, the processing system includes logic to accumulate a plurality of data sets each including locations of the identified subject, gaze directions of the subject, items in area of real space matching the identified gaze directions, distances of identified subjects from items, and/or the determined lengths of times. The system can store the accumulated data sets in the database configured for use to analyze the data to correlate a particular element of a plurality of data sets with other elements in the plurality of data sets related to the particular element. The system can further track the path and traversal of a subject throughout the area of real space and use a model, such as a hidden Markov model or a deep learning model, to predict the future path or a notion of intent for the subject. Attributes such as dwell and gaze can be refined into a multidimensional impression attribute. Impression may further include attributes such as subject velocity and direction to focus on what the subject is engaging with and searching for versus what the subject is not displaying any signs of interest in.

### Implementation of Personalized Presentation Data Using Computer Vision

The computer vision components of the disclosed system that are leveraged to monitor cashier-less transactions, including subject tracking, identification of objects and tracking subject interactions with the identified objects, and directional gaze detection can be further leveraged to collect retailing data as well as providing personalized presentation data. FIGS. 5A, 5B, and 5C illustrate an exemplary implementation including personalized presentation data triggered by a subject's behavior in the area of real space, such as location within the area of real space and item interactions such as takes. The representative examples in FIGS. 5A and 5B illustrate a subject within a corridor of an area of real space. While the subject moves throughout an area of real space, their location and interactions with objects are tracked using computer vision and/or optional location tracking of the subject's mobile device. When the camera system detects the subject taking an object, like the bottle of Pop Drink 502 in FIGS. 5A and 5B, the subject's “digital cart,” or an object data structure tracking objects engaged with by the subject, is updated to include the bottle of Pop. This data can be collected and processed to trigger the presentation of personalized presentation data for the subject. More specifically, subject data like the subject's path and actions are connected with the object identified by the disclosed system as Pop Drink 502. The presentation data is calibrated in dependence on the connections between the subject data and Pop Drink 502. Other connections beyond the subject's decision to pick up the Pop Drink 502 may also include the subject's dwell within the soda corridor, the subject's visual association with the Pop Drink 502 compared to similar alternative drinks, and/or a sentiment analysis of the detected subject in connection with the Pop Drink 502. The calibrated presentation data is provided to the subject via a presentation medium like a display device.

In some implementations, the presentation data is triggered on a display located within the corridor. The display can be a touch-screen display, for example, or any other type of graphical user interface that allows a user to provide input and interact with the display. In some implementations, users can interact with personalized and interactive presentation data or surveys in order to receive presentation data. In other implementations, users may download an application onto their smart phone or smart watch devices and receive presentation data via push notifications in their user applications.

FIG. 5A shows a subject 504 within the area of real space standing in front of a display. The display includes shelves of a Popular Drink (“Pop”) 502. The subject tracking engine detects the location of the subject in front of the Pop display. Other information that may be collected about the subject activity, such as the subject picking up or touching an object in the display, the amount of time that the subject has been standing near the Pop display, and detecting that the subject's gaze has been directed towards the subject display, may also be processed and influence the decision to send personalized presentation data to the subject. In FIG. 5A, the subject has picked up a Pop bottle 502 to place it in her basket.

This interaction results in the subject 504 receiving personalized presentation data, via a display 524 of a device or the subject's personal device, after the subject places one bottle of Pop into her basket. The push notification alerts the subject of presentation data stating that if they obtain two bottles of Pop, they can receive a discount of $0.50 off the value (amount to be paid for) of the two bottles. In some implementations, the presentation data is time limited. For example, the presentation will expire in 20 minutes and 15 seconds if not utilized, motivating the subject to obtain two bottles of Pop in the current trip. In other implementations, the presentation data may have a longer or shorter expiration period, and the expiration period may be long enough that the presentation data is still valid on a future date.

In one implementation, the subject may receive the personalized presentation data push notification before they have placed an item into their basket. For example, the collected computer vision data may be processed to predict that the subject will soon approach the Pop display, triggering a push notification. Alternatively, the push notification may be triggered by the subject reaching a certain proximity threshold to the display, such as five or three feet, or the subject remaining within the proximity threshold (i.e., dwelling) and/or directing their gaze towards the display for a pre-defined minimum period of time, such as five or ten seconds. For example, FIG. 5B illustrates a similar scenario to that of FIG. 5A; however, the subject 504 docs not need to physically interact with the Pop 502. Instead, the directional impression of the subject onto the Pop 502 is sufficient. In other implementations, previous choices within the area of real space or subject trajectory may inform personalized presentation data. In another implementation, the subject may receive a personalized presentation data as a push notification for products that they have obtained before in one or more previous trips and they interact with the same area of the area of real space where the product is located within a present trip. In yet another implementation, personalized presentation data may be provided to a subject based on their activity within the present trip (e.g., manufacturer presentation data for a discount on 3 of their products once a subject has placed one of their products into their cart, or a personalized presentation data is triggered when a correlated item is obtained such as a discount on pasta sauce after a subject places a box of pasta into their cart).

In certain implementations, the shelves in the area of real space are equipped with electronic shelf labels (ESL), enabling dynamic valuing and/or discounts. Instead of utilizing presentation data from a push notification, or in combination with the push notification of the presentation data, the subject sees the discount applied in the form of a lower value on the shelf label. In certain scenarios, subjects may be more likely to obtain an object in response to a specific discount via presentation data (e.g., an object that is typically $7.99, with presentation data of 50% off) while in other scenarios where the math is less straightforward, subjects may be more responsive to seeing a specific value after discount (e.g., an object that is typically $7.99, with presentation data of 30% off is easier to conceptualize when the subject sees the value reduction to $5.59). In order to accurately apply the correct value for a subject upon checkout, the retail system must access the data associated with the subject track to retrieve the proper discount for the subject.

FIG. 5C shows additional examples of personalized presentation data 506, 508 that can be presented to a subject, such as a “Buy 2, get $1.50 off” for a particular object (presentation data 506) or $1.00 off from the value of an object (e.g., $1.00 off a candy bar, or a $1.00 discount if the subject obtains two items from Eggscellent Foods, as illustrated within presentation data 508). The subject can tap the “utilize” (or equivalent thereof) input button to utilize the presentation data until the expiration timer runs out.

### Camera System

Multiple cameras with overlapping fields of view can capture subjects and interactions of subjects as described above. The cameras or sensors can have overlapping fields of view to detect subjects and their interactions.

Various implementations of the technology can include the use of cameras with a range of hardware specifications. The cameras can be implemented with or without an ethernet jack. The cameras can include a PCIE connection and/or a USB connection. The cameras can implement pixel binning. The cameras can have a dome shape to an annulus shape with flat (e.g., glass) cover. The cameras can include an internal solid state drive (SSD), with storage ranging from, for example, 500 GB to 2 TB. The cameras can have a resolution of 13 MP, can be auto focus and/or fixed focus and can have a variable framerate. The cameras can operation in a low temperature environment, such as a refrigerator (e.g., 10 degrees Celsius). Humidity can be addressed using a desiccant. A heat sink can be included on the exterior of the cameras. A scaling can be provided between the camera and the surface to which it is attached (e.g., a ceiling) or the cameras can have a grommet and/or ring insert configuration.

The cameras can have various electrical configurations. For example, the cameras can include an ethernet interface (RGMII with PoE+). The cameras can include one or more systems on modules (SOMs) that can be connected by USB and//or PCIe for communications.

The cameras can implement internal (e.g., edge) processing to combine multiple frames of data to capture changes and/or movement spread across several frames into one frame and can reduce a number of frames by eliminating frames that do not capture any background or foreground changes. The cameras can implement various coding and data reduction techniques to stream sensor data to servers on our off premises, even under low bandwidth conditions (e.g., less than 5 MP per second). The cameras can implement AI models to process and analyze data before sensor data is transmitted to other devices and the cameras can implements algorithms to determine depts and can perform pixel level diffing.

The cameras described herein can include Bluetooth (or other short distance communication) capabilities to communicate to other cameras and/or other devices within the area of real space.

### Network Configuration

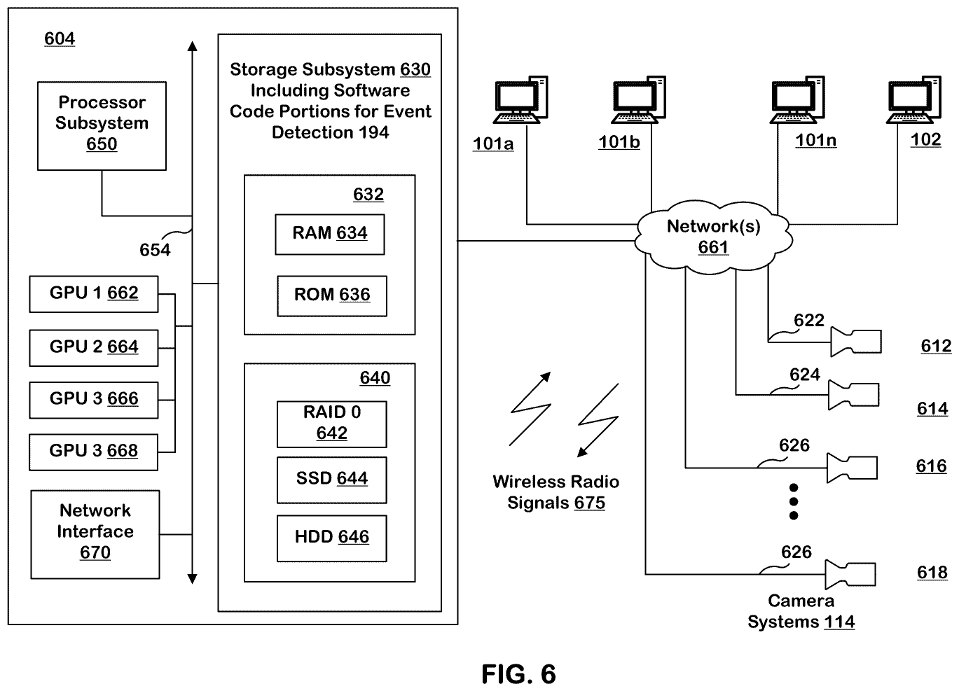

FIG. 6 presents the architecture of a network including a network node (or computer system) 604. The system includes a plurality of network nodes 101a, 101b, 101n, and 102 in the illustrated implementation. In such an implementation, the network nodes are also referred to as processing platforms. Processing platforms (network nodes) 101a, 101b, 101n, 102, 104, 106 and camera systems (114) including 612, 614, 616, . . . , 618 are connected to network(s) 681.

FIG. 6 shows a plurality of camera systems 612, 614, 616, . . . , 618 connected to the network(s). A large number of cameras can be deployed in particular systems. In one implementation, the camera systems 612 to 618 are connected to the network(s) 681 using Ethernet-based connectors 622, 624, 626, and 628, respectively. In such an implementation, the Ethernet-based connectors have a data transfer speed of 1 gigabit per second, also referred to as Gigabit Ethernet. It is understood that in other implementations, camera systems 114 are connected to the network using other types of network connections which can have a faster or slower data transfer rate than Gigabit Ethernet. Also, in alternative implementations, a set of cameras can be connected directly to each processing platform, and the processing platforms can be coupled to a network.

Storage subsystem 630 stores the basic programming and data constructs that provide the functionality of certain implementations of the technology disclosed. For example, the various modules implementing the functionality of the event detection and classification engine 194 may be stored in storage subsystem 630. The storage subsystem 630 is an example of a computer readable memory comprising a non-transitory data storage medium, having computer instructions stored in the memory executable by a computer to perform all or any combination of the data processing and image processing functions described herein including logic to track subjects, logic to detect object events, logic to predict paths of new subjects in an area of real space, logic to predict impact on movements of subjects in the area of real space when locations of shelves or shelf sections are changed, logic to determine locations of tracked subjects represented in the images, logic match the tracked subjects with user accounts by identifying locations of mobile computing devices executing client applications in the area of real space by processes as described herein. In other examples, the computer instructions can be stored in other types of memory, including portable memory that comprise a non-transitory data storage medium or media, readable by a computer.

These software modules are generally executed by a processor subsystem 650. A host memory subsystem 632 typically includes a number of memories including a main random access memory (RAM) 634 for storage of instructions and data during program execution and a read-only memory (ROM) 636 in which fixed instructions are stored. In one implementation, the RAM 634 is used as a buffer for storing re-identification vectors generated by the event detection and classification engine 194.

A file storage subsystem 640 provides persistent storage for program and data files. In an example implementation, the file storage subsystem 640 includes four 120 Gigabyte (GB) solid state disks (SSD) in a RAID 0 (redundant array of independent disks) arrangement, as identified by reference element 642. In the example implementation, maps data in the database 140, item data in the items database 150, store maps in the map database 160, camera placement data in the camera placement database 170, camograms database 180 and video/image data in the video/image database 190 which is not in RAM, is stored in RAID 0. In the example implementation, the hard disk drive (HDD) 646 is slower in access speed than the RAID 0 (842) storage. The solid state disk (SSD) 644 contains the operating system and related files for the event detection and classification engine 194.

In an example configuration, four cameras 612, 614, 616, 618, are connected to the processing platform (network node) 604. Each camera has a dedicated graphics processing unit GPU 1 662, GPU 2 664, GPU 3 666, and GPU 4 668, to process images sent by the camera. It is understood that fewer than or more than three cameras can be connected per processing platform. Accordingly, fewer or more GPUs are configured in the network node so that each camera has a dedicated GPU for processing the image frames received from the camera. The processor subsystem 650, the storage subsystem 630 and the GPUs 662, 664, 666 and 668 communicate using the bus subsystem 654.

A network interface subsystem 670 is connected to the bus subsystem 654 forming part of the processing platform (network node) 604. Network interface subsystem 670 provides an interface to outside networks, including an interface to corresponding interface devices in other computer systems. The network interface subsystem 670 allows the processing platform to communicate over the network either by using cables (or wires) or wirelessly. The wireless radio signals 675 emitted by the mobile computing devices in the area of real space are received (via the wireless access points) by the network interface subsystem 670 for processing by an account matching engine. A number of peripheral devices such as user interface output devices and user interface input devices are also connected to the bus subsystem 654 forming part of the processing platform (network node) 604. These subsystems and devices are intentionally not shown in FIG. 6 to improve the clarity of the description. Although bus subsystem 654 is shown schematically as a single bus, alternative implementations of the bus subsystem may use multiple busses.

In one implementation, the camera systems 114 can comprise a plurality of NFOV image sensors and at least one WFOV image sensor. Various types of image sensors (or cameras) such can be used such as Chameleon3 1.3 MP Color USB3 Vision (Sony ICX445), having a resolution of 1288×964, a frame rate of 30 FPS, and at 1.3 MegaPixels per image, with Varifocal Lens having a working distance (mm) of 300-∞, a field of view field of view with a ⅓″ sensor of 98.2°-23.8°. The cameras 114 can be any of Pan-Tilt-Zoom cameras, 360-degree cameras, and/or combinations thereof that can be installed in the real space.

### Various Implementations

The technology disclosed relates to providing presentation data to a subject in an area of real space. The presentation data can include textual data, graphics, stylized content, data visualizations, etc. In some implementations, the presentation data can include user interactive elements like drop-down lists, user input fields, or interactive buttons. The presentation data can be compatible with digital, print, audio, video, and/or other forms of media. The presentation data can include informational content, such as a help guide or nutritional information about a food item. Alternatively, the presentation data can include data summaries or analyses. The presentation data is provided to a user, such as a subject in an area of real space. Prior to a presentation of the presentation data being triggered, the presentation can be calibrated, e.g., to personalize the presentation data for the subject in the area of real space or another contextual factor like environment, time of day or year, and so on.

Method implementations can comprise obtaining respective sequences of frames of corresponding fields of view in an area of real space from a plurality of sensors and/or cameras. The method can further comprise detecting a subject in the area of real space and analyzing a sequence of frames in the respective sequences of space. The analysis can include identifying objects in the area of real space and identifying subject behavior of the detected subject in the area of real space. The objects in the area of real space may be tangible goods and products (“items”), for example. The method can include identifying subject data with respect to the identified objects. The subject data can relate to one or more of a location of the detected subject, a path of the detected subject, a velocity of the detected subject, an orientation of the detected subject (which may further include body orientation, head orientation, gaze, positioning, etc.), and/or an action of the detected subject. The subject data can also include a behavior of the detected subject, a demographic of the detected subject, a pose of the detected subject, a sentiment of the detected subject, a pattern, trend, or history associated with the subject data for the detected subject, a classification of one or more types of subject data, and/or a prediction of future subject data. The subject data may be determined with respect to a single subject or a plurality of subjects. For example, multiple subject tracks corresponding to respective subjects may be identified as a group, e.g., based on triangulation of trajectories corresponding to the tracks and/or correlated subject characteristics between subjects within a group. The subject data may further include data that has undergone pre-processing, transformation, feature engineering, encoding, and/or post-processing. The subject data may be quantitative, qualitative, and/or multidimensional.

The method can include identifying a connection between the identified subject data of the detected subject and a particular identified object. In some implementations, the method includes identifying connections between multiple respective types of identified subject data and the particular identified object. In other implementations, the method includes identifying connections between the identified subject data and multiple identified objects. In certain implementations, the exact identity of the particular object may be unknown. The identified object may be identified by one or more particular features, a title or classification identifier, a grouping, a brand name, a serial number, etc.

The method can further include calibrating presentation data in dependence on the identified connection between the identified subject data of the detected subject and the particular identified object. The calibration can include generating data de novo based on the identified subject data, identified object(s), and/or connections thereof. The calibration can include extracting data from a database or dataset to be included in the presentation data, or filtering data out from a database or dataset to be excluded in the presentation data. The calibration can include employing an optimization algorithm to refine, fine-tune, minimize, or maximize a particular feature of the presentation data. The calibration can include identifying a best-fit match as presentation data from a plurality of presentation data options based on the identified subject data, identified object(s), and/or connections thereof. The calibration may be performed by an algorithmic process, a manual user calibration process, a machine learning or artificial intelligence process, a criteria set, or a rule schema. The calibration may be performed directly, or indirectly via communication with an application, API, or cloud service, for example. The calibration may further involve communication with a data brokerage service.

In some implementations, the calibration is performed in further dependence on data associated with the particular identified object, one or more different identified objects, the area of real space, or additional constraints such as retailing configurations or appropriateness controls. In some implementations, the calibration is performed in further dependence on the detected subject's prior interactions with other presentation data. In some implementations, presentation data may be calibrated multiple times over the course of multiple iterations. Re-calibration may occur in response to data correction, updated data, feedback loops, or a pre-determined regular time interval. In some implementations, multiple test versions of the presentation data are generated and triggering presentation of the presentation data includes presenting one of the multiple test versions at random. Future versions of the presentation data can be calibrated in dependence on the respective performances corresponding to each of the multiple test versions. In other implementations, different experimental variables and controls influence the calibration of the presentation data for research purposes, such as retailing and presentation data research or analytics.

In some implementations, the method can include determining, from the identified subject data with respect to an identified object, a subject impression onto the particular object. In one example implementation, subject behavior with respect to the particular object is used to determine if the subject has made an interactive impression onto the particular object or a directional impression onto the particular object. In another example implementation, subject behavior with respect to one or more objects is used to make a classification of the subject's behavior as a targeted seeking behavior for a particular item or category of items, or as an untargeted browsing behavior that is uncorrelated to any particular object or category of items. In certain implementations, a connection is identified between subject data of the detected subject with one object or object based on another connection identified between subject data of the detected subject with another different object or object.

The method can also include triggering a presentation of the calibrated presentation data to the detected subject. In some implementations, the method includes triggering a presentation of personalized information in dependence on the subject data with respect to a particular object. In one implementation, the personalized information is personalized presentation data associated with the particular object. The detected subject can further interact with the personalized presentation data to accept the presentation data. Future presentation data may be calibrated in dependence on how the detected subject has engaged with previous presentation data, such as whether the detected subject accepted previous presentation data. Some method implementations can further comprise collecting subject data with respect to presentation data presented to one or more subjects and analyzing the collected subject data.

In some implementations of the technology disclosed, the subject data relates to an action of the detected subject and includes the detected subject altering a location or position of any identified object, e.g., picking up, putting down, rotating, or otherwise physically manipulating an object like an object. In some implementations, the subject data relates to a connection between the detected subject and another detected subject. In other implementations, the subject data relates to a prediction of future subject data based on collected subject data such as timeseries data. Future subject data can include a future path trajectory or a future connection between the subject and a particular identified object.

Some implementations include analyzing a visual association field of the detected subject. The visual association field can be segmented into at least two regions within the visual association field, and a visual association of the detected subject with respect to a region of the visual association field is measured in dependence on the head orientation of the detected subject. The head orientation of the detected subject can be leveraged as a proxy for visual gaze direction of the detected subject. In other implementations, retinal tracking is used to measure visual association. The two or more regions within the visual association field can be assigned weights based on the visual association of the detected subject for one respective region relative to the other relative regions of the visual association field. Hence, if a subject gazes at one region significantly more than the other regions, said one region will be weighted more heavily than the other regions and vice versa. In some implementations, the visual association field is a visual engagement field relating to the intensity with which a detected subject is visually engaging with particular regions of their visual field. Intensity can be measured as a length of gaze time in the direction of a particular region, location within the detected subject's field of view and focal length, frequency of gaze instances towards the particular region, and so on. Visual engagement, or visual associations in general, can be measured as independent values (e.g., raw time measurements for length of gaze) or related values (e.g., weighted measurements indicating relative intensities corresponding to respective regions). In addition to the identification of regions within a visual engagement field that a detected subject is engaged with, the disclosed system may further identify peripheral regions of interest for the detected subject with respect to engagement. Implementations describing visual engagement fields can also use visual association fields instead of, or in addition to, visual engagement fields, and vice versa. An area of real space, such as a display, corridor, or approximate line-of-sight from a particular vantage point, can be segmented into any number of subregions (referred to generally as “regions”).

The segmentation of an area of real space into regions, e.g., with respect to visual association or visual engagement fields, may be performed based on the division of space into nonoverlapping regions of equal area. In some implementations, the regions can be overlapping. The segmentation into regions may also be performed in dependence on groupings of objects, e.g., regions corresponding to particular shelves on a shelving unit, categories of products such as chips versus pretzels, categories of brands such as one cereal manufacturer versus another, or individual object facings such that the regions are identified on a per-object basis. The segmentation of regions may be layered such that a region is divided into a number of subregions for any number of hierarchical levels. For example, a corridor in an area of real space or a manufacturing facility may be initially segmented into a number of regions in dependence on product categories like baking mixes, frosting, and sugar. The regions corresponding to product categories can be further segmented into brands (e.g., Region 1 corresponding to Baking Mix Brand 1 and Region 2 corresponding to Baking Mix Brand 2) or subcategories (e.g., Region 1 corresponding to Cake Mixes and Region 2 corresponding to Brownie Mixes). Additional layers of nested segmentation can be added, such as a Region 1 corresponding to Cake Mixes being further segmented into a region per each unique object within Region 1. Other segmentation processes, and naming systems, can be implemented as well. In one implementation, a region may correspond to noncontinuous areas of space. For example, if objects are arranged on shelves by type of product instead of brands (e.g., a canned vegetable corridor where canned peas are arranged together, canned corn is arranged together, and so on), a region may cumulatively include multiple discontinuous areas of space where products from a specific brand are located (e.g., all Brand cans in the canned vegetable corridor).

In some implementations, segmentation and identification of regions within a visual engagement field or visual association field is performed in dependence on a camogram or reference data indicating expected locations of particular objects. The disclosed system can leverage visual association fields for the identification of subject data. For example, distributions of visual associations (i.e., direction of subject gaze) can be used to make inferences about behavior for a detected subject, like targeted seeking behavior for a particular type of product, brand, or specific item, or general browsing behavior wherein the subject is not engaging visually with any regions more than others. Visual association fields may also be leveraged to infer additional subject data such as sentiments about specific objects, such as interest in a specific item, or more generalized subject preferences, such as classifying a detected subject as vegetarian based on their engagement with vegetarian meat substitutes relative to meat products. Other types of subject data that may be determined based, at least partially, on visual engagement can include budgets based on the value ranges a subject visually engages with, brand loyalties, and decision-making behaviors (e.g., impulse-decision subjects compared to subjects that carefully inspect different options prior to selection).

The disclosed system can leverage visual association fields for the identification of connections between identified subject data and a particular identified object. In one example implementation, the disclosed system can identify subject data indicating that a subject in an area of real space is looking at a shelving display including a plurality of different objects. If a subject selects an item from the shelving display and places it in their cart or basket, it is easy to determine that the subject is interacting with the selected item. However, subjects may look at a display for an extended period of time without ever taking any items off the shelf. Furthermore, a subject may have considered a number of different items prior to selecting only a subset of one or more items that were considered, opting not to select other items. Certain implementations may comprise identifying subject data including alternative items or brands considered, but not obtained, in comparison to an item selected for taking. The subject's visual engagement field can be used as a proxy for implicit subject interactions. Visual engagement metrics, like frequency or duration of visual engagement with a particular item or region of items, can be used independently or in combination with other subject data as a proxy for likelihood that a particular object is connected to particular subject data. In one example, a connection is identified between identified subject gaze and/or dwell and a particular identified object based on a higher degree of visual engagement with the particular identified object compared to other identified objects within the subject's approximate visual line of sight. In some implementations, probabilities or scoring metrics are computed based on a plurality of subject data sources to connect a particular subject data to a particular identified object.

An example will now be provided to illustrate how visual engagement fields can be leveraged to identify connections between identified subject data of a detected subject and a particular object in the area of real space. Alternative use cases that fall within the scope of the technology disclosed will be readily apparent to users skilled in the art. Analysis of a subject's visual engagement field while examining a dairy refrigeration case indicates that a subject may be visually engaging with butter, sour cream, or flavored spreadable cream cheeses. Based on a proximity of the three categories of items, a resolution of the camera being used, and/or occlusions partially blocking the subject's head or face, it is unclear from the visual engagement field data whether the detected subject is visually engaging with the butter, sour cream, or cream cheeses. However, previously obtained subject data (or a current state of the detected subject's basket) shows that the detected subject has previously selected flour, sugar, and chocolate chips. Based on correlations between these items, an inference can be made that the subject is most likely visually engaging with the butter based on correlation data accessible to the system. Hence, a connection is identified between the subject data (gaze and dwell) and a particular identified item (butter). In one implementation, this connection is used to calibrate presentation data relating to suggested recipes, and the disclosed system triggers presentation of a chocolate chip cookie recipe via a display. In another implementation, this connection is used to calibrate presentation data relating to presentation data, and the disclosed system triggers presentation of presentation data for a specific type of butter. In yet another implementation, the calibrated presentation data may be further calibrated based on subsequently identified subject data. The subject may subsequently select an organic, vegan butter substitute from the refrigeration display and place it into her cart, prior to moving to the location of milk products. If further calibration were not performed, the disclosed system could potentially trigger display of presentation data for dairy milk from the same farm provider associated with the previous butter presentation data. However, the presentation data is calibrated in dependence on (i) the connection between the subject's dwell and the identified milk products and (ii) the earlier connection between the subject's selection action and the organic vegan butter substitute. The resulting calibrated presentation data is for an organic oat milk brand. Hence, the subject experience and presentation of real-time presentation data is personalized to the subject without the need for any personal identifying data of the subject.

Other implementations involving visual engagement fields relate to different use cases. In one example, the technology disclosed can be used in presentation data research studies to evaluate effectiveness of a new product design. In another example, the technology disclosed can be used to detect cheating in a secure exam center. In yet another example, the technology disclosed can be used to improve accuracy of information and communication technologies (ICT) used as accessibility aids for individuals with disabilities. Additional examples may include virtual reality/augmented reality (VR/AR) use cases, such as the use of AR devices like the Apple Vision Pro®, or AR/VR-based video games for a personalized gaming experience.

Alternatively, or in addition to visual association fields, various implementations of the technology disclosed can identify connections between identified subject data and a particular identified object via correlating the identified subject data of the detected subject with the particular identified object, and classifying the identified subject data as correlated or uncorrelated to the particular identified object. Other implementations identify connections between identified subject data and a particular identified object via correlating the particular identified object with other identified objects.

In one disclosed method, a connection is identified between identified subject data and presentation data that has been presented to a detected subject, i.e., the particular identified object connected to identified subject data for the detected subject is the presentation data. For example, subject data can be identified and connected to personalized presentation data (or other presentation data) that was presented to the subject. In one example, the subject data is an interaction with the personalized presentation data, e.g., accepting the presentation data after viewing the presentation data. In another example, the subject data is dwell, gaze, or another orientation or impression metric connected to the personalized presentation data that can be leveraged to infer subject interest in the personalized presentation data. In another example, the subject data is a selection of a particular object following presentation of personalized presentation data for the particular object.

In some implementations, analytics data associated with at least one performance metric for the presentation data is collected. Performance metrics can be consumer engagement or conversion rate, for example. In other implementations, analytics data may be associated with performance metrics associated with a particular identified object. Performance metrics may be quantitative or qualitative statistics relating to the frequency or type of connections identified between subject data and the particular identified objects. A limitless number of analytics questions valuable for operational efficiency and/or retailing purposes can be answered leveraging the technology disclosed, including but not limited to: How popular is a particular product, brand, or trend? What information can we obtain about the consumers who are obtaining a particular product, brand, or trend? What are the main competitors for a product or brand? How is a brand or product re-design performing? What is the optimal value point for a particular product? Is throughput of items being lost due to shrinkage, out-of-stock items, or a particular object display arrangement? Are subjects more likely to obtain a product when they are accompanied by others, such as a child? How effective is presentation data? Is one design strategy more effective than another? How efficiently are assistants managing object stock levels? What types of products are being frequently bought together? In many implementations, the presentation data being calibrated corresponds to similar such analytics questions for presentation to a representative, brand representative, etc. In some implementations, the presentation data is calibrated for a GUI and/or a data visualization. Data visualizations may include graphs, time-lapses, summary statistics, and/or heat maps.

Many disclosed implementations leverage data collected about a subject track, such as subject location, path trajectory, dwelling and directional gaze, and interactions with objects, to trigger personalized presentation data for the subject. In many implementations, the presentation data is presented to the subject via a display or a client application on their mobile device. In some implementations, the disclosed method includes receiving subject data provided by the detected subject (e.g., via a client application on a client device) and calibrating presentation data based on the received subject data and/or triggering personalized presentation data based on the received subject data. The client application can be linked to the subject's user account, enabling for a digital cart to keep track of the items that a subject places in their physical cart/basket. In other implementations, a digital cart data structure can be constructed by tracking each object taken off a shelf by an anonymous subject without any need for a subject account. Accordingly, when a subject places an item in their cart that they have utilized presentation data for (either because presentation data was triggered because the item was placed in the subject's cart, or because the presentation data influenced the subject to place the item in their cart), the discount is automatically applied to the total cost of the subject's digital cart at check-out. Some implementations of the technology disclosed trigger personalized presentation data in area of real spaces without the use of transactions, and the cashier applies the discount from the user's account during check-out.

In one implementation, the subject does not have a user account with the client application, preventing the ability to trigger presentation data via their mobile phone. Alternatively, the data collected that is used to trigger the presentation data push notifications may also be used to present other presentation data materials on a display in the area of real space near the subject location.

Some implementations of the disclosed system include presentation data being triggered by at least one of a subject track, a predicted subject trajectory, a subject dwelling in the proximity of a shelf or display, the detected gaze direction of the subject, a take or put action, a subject physically touching an object, a subject looking up the object within the client application, or generalized presentation data that are run by the area of real space management, manufacturer, or distributor of objects. In one implementation, the disclosed system is configured to predict the future path/trajectory of a subject based on their previous trajectory and/or interactions within the area of real space and/or based on their current trajectory and/or interactions. The predicted future path is processed to predict a corresponding presentation data for the subject. For example, the location trajectory of a subject may be processed to generate a prediction that the subject is going towards the wine section of an area of real space, and this prediction triggers a personalized presentation data for wine to be presented to the subject. In some implementations, a hidden Markov model, deep learning model, or other machine learning/artificial intelligence model is used to predict subject path, intent, or engagement. Many implementations comprise detecting head orientation of a subject to determine a visual engagement distribution and subsequently determine subject gaze, which can be performed with many common camera systems and does not require complex sensor configurations or retinal tracking sensors.

One implementation involves using a sequence of frames produced by a corresponding sensor in the plurality of sensors in a first inference engine to identify objects in the sequence of frames. Another implementation further involves using outputs of the first inference engine over a period of time in a second inference engine to identify the subject data of the detected subject. Other implementations further involve using outputs of the first and second inference engines over a period of time in a third inference engine to identify connections between the identified subject data of the detected subject and the identified objects.

In many implementations, tracked subject behavior such as path, dwell, and gaze can be used to distinguish between general browsing behavior and targeted seeking behavior. For example, a subject who is not dwelling in any particular locations, or gazing/moving in any predictable pattern is likely to be browsing whereas a subject that is moving, gazing, or dwelling in a particular pattern is likely to be searching for specific, targeted products. Pattern recognition and threshold for detecting seeking can be performed with computer vision detection models, such as those disclosed herein. Computer vision models used for tracking subjects and subject behavior is discussed further in commonly owned U.S. Pat. No. 11,544,866, titled “Directional Impression Analysis Using Deep Learning,” and U.S. Pat. No. 11,250,376, titled “Product Correlation Analysis Using Deep Learning,” both of which are incorporated by reference herein in their entirety for all purposes.

In one implementation, the presentation data is provided by the area of real space while in other implementations, the manufacturer has sponsored the presentation data. Presentation data may be triggered by the subject interacting with the object to which the presentation data is applied, or alternatively, interaction with an item that is associated with the applicable object can trigger the presentation data for the applicable object (e.g., a subject takes pasta off the shelf and gets a presentation data for pasta sauce from the same manufacturer brand, or similarly related foods like ice cream/sugar container, beverage, beverage creamer, and so on). Presentation data may be seasonal (e.g., presentation data for popsicles in the summer or for pumpkin spice flavored products in the fall), holiday-related (e.g., candy canes at Christmas time), or associated with a new manufacturer product or a selling event.

The technology disclosed also involves generating personalized presentation data triggered by a combination of data collected from the present trip for a subject (e.g., subject track, takes/puts, directional gaze detections, etc.) and other data associated with the subject's user account, such as history, demographic data, and subject preferences. For example, a subject may have previously indicated that they prefer vegetarian options via customization settings or survey responses. Alternatively, subjects over the age of 21 may be presented with presentation data for alcoholic products. If a subject has opted for organic foods over non-organic foods in previous trips, the subject can be presented with presentation data for organic options when the subject is within proximity of said organic objects.

In some implementations, the relevancy of the presentation data presented to a subject is improved by leveraging UWB protocols to detect accurate specific locations of the subject within the area of real space. In other implementations, directional gaze detection is used to inform more relevant presentation data to the subject's interests.

The technology disclosed may be used to track actions that are not defined by the picking up or putting down of a product, such as the visual inspection of a product for a pre-defined threshold period of time or touching a product without picking it up (e.g., spinning the product around to examine the nutrition label), or a product-independent action like the opening of a cash drawer or other equipment/objects within the area of real space. In certain implementations, the disclosed system is configured to trigger presentation data for a subject independently of whether or not the item was properly shelved. Even though the product did not correspond to the location on the shelf where it was found, or even within a different corridor entirely, the system can accurately identify the object based on the appearance of the product alone, and the presentation data is generated in response to the subject's behavior independently of being near a display or other specific location within the area of real space. Some implementations relate to monitoring stock management of identified objects or other objects. In one implementation, the disclosed system monitors a quantity of the particular identified object located within the area of real space. For example, the disclosed system may identify out-of-stock or low stock items in dependence on the identified items, identified subject data, and connections between the identified subject data and identified items. In many implementations, the calibration of presentation is dependent upon the quantity of an identified object (i.e., low or out-of-stock items). For example, if a particular object is out of stock, the disclosed system will not trigger presentation of presentation data for the out-of-stock item.

In another implementation, the disclosed system monitors the location of identified objects located in corridors or otherwise within the area of real space. For example, the disclosed system may identify improperly shelved items in dependence on the identified items, identified subject data, and connections between the identified subject data and identified items. The disclosed system can identify an improperly shelved item based on detection of a subject picking up an item from one location and placing it in another, different location. The disclosed system can also identify an improperly located object based on a comparison of the actual location of an identified object in corridors or otherwise in the area of real space versus an expected location of an identified object in corridors or otherwise in the area of real space, e.g., using a camogram map or reference directory of objects. In one implementation, the disclosed system can monitor subject data connected to one or more specific objects of heightened interest, such as items costing more than a pre-determined value threshold, items that are commonly targeted for theft, restricted items like alcohol or tobacco products, controlled substances in a controlled location, or cash registers in an environment.

In some implementations, the disclosed system is further leveraged to collect retailing analytics such as tracking subject engagement in corridors or otherwise within area of real space presentation data content and effectiveness of the presentation data personalization. The subject impression data may be used as a precursor to inform the creation of area of real space presentation data, after in area of real space deployment for behavioral research, collecting subject conversion rates, tracking lost opportunities and new product roll-out metrics, triaging opportunities, identifying subject cohorts and informing adjudication between subjects, constructing behavior maps to dissect data related to item value/amount, or retailing strategy, performing A/B testing of presentation data, fine-tuning presentation data content based on subject responsiveness, and so on. In some implementations, subject interaction with objects and/or personalized items in corridors or otherwise in areas of real space presentation data can further trigger generation of on-receipt presentation data for subjects at check-out.

Some implementations involve a system for monitoring object stock levels. Computer vision systems for monitoring object stock (e.g., leveraging camograms and tracking takes/puts from subjects) can be combined with the retailing analytics data collected in association with the personalized system to infer the potential effectiveness of presentation data for a particular out-of-stock object, had that object been in stock. The system can perform monitoring of object stock levels in dependence upon detected interactions between detected subjects and identified objects, wherein the triggering of personalized presentation data is dependent upon the quantity of the particular identified object.

Other implementations include a method comprising producing subject events that occur in corridors or otherwise in the area of real space corresponding to identified subject data of a detected subject, wherein each of the subject events includes one or more of a subject identifier of the detected subject, particular identified subject data of the detected subject, a location in corridors or otherwise in the area of real space, and a timestamp. The method further comprises constructing a chronologically ordered sequence of subject events associated with the detected subject and calibrating presentation data in dependence on the chronologically ordered sequence of subject events associated with the detected subjects. In certain implementations, identifying the connection between the identified subject data of the detected subject and the particular identified object further includes correlating the identified subject data of the detected subject with a region in corridors or otherwise in the area of real space, identifying a set of one or more identified objects associated with the region, wherein the set of one or more identified objects includes the particular identified object, and producing a connection probability with respect to each identified object within the set of identified objects. Each respective connection probability can correspond to a likelihood that the identified subject data of the detected subject is connected to a respective identified object, and an identified object from the set of identified objects is selected as the particular identified object based on the identified object having the highest connection probability.

In another implementation, the method includes tracking a behavior of the detected subject, wherein the tracked behavior includes one or more of a velocity, an orientation, and/or a gaze of the detected subject, and producing subject behavioral events occurring in corridors or otherwise in the area of real space. Subject behavioral events can each include one or more of a subject identifier of the detected subject, a tracked behavior, a location in corridors or otherwise in corridors or otherwise in the area of real space, and a timestamp. The method can further include constructing a chronologically ordered sequence of subject behavioral events associated with the detected subject and correlating the chronologically ordered sequence of subject behavioral events with a chronologically ordered sequence of object events, wherein an object event may be a take or put event for an object. The correlation can be identified using the timestamps of the respective chronologically ordered events. The chronologically ordered sequence of subject behavioral events can further be correlated with an object map including locations corresponding to objects, and the correlation can be analyzed with respect to any subject behavioral event of the chronologically ordered sequence of subject behavioral events. The method can further include identifying a plurality of target objects based on a correlation between the location of respective target objects of the plurality of target objects and the subject behavioral event. The method can further include computing a set of impression probabilities, each impression probability corresponding to a likelihood that the subject behavioral event is a subject impression on a respective target object of the plurality of target objects, wherein each impression probability is based on one or more of a location of the detected subject, a location associated with one or more tracked behaviors of the detected subject, and/or a location of a respective object.

In one implementation, the disclosed system identifies subject data of the detected subject and a connection between the identified subject data and an identified object, and calibrating presentation data in dependence on the identified connection. The disclosed system can further identify other subject data of the detected subject and another connection between the other subject data and another identified object. The disclosed system can additionally further calibrate the calibrated presentation data in dependence on the other connection between the other subject data and the other identified object, and triggering a presentation of the further calibrated presentation data to the detected subject. In some implementations, the presentation data can be iteratively calibrated in any number of calibrations that occur successively or concurrently. In some implementations, the presentation data is calibrated two or more times prior to the triggering of the presentation of the calibrated presentation data.

In some implementations, the calibrated presentation data is presented to a user, such as the detected subject, via a user interface. In one implementation, the calibrated presentation data is personalized presentation data. In another implementation, a data set is determined including object events for a particular object, wherein the object events include one or more of an identifier for an identified object, an interaction between a detected subject and the identified object, a location in corridors or otherwise in the area of real space, and/or a timestamp. The particular object may have multiple object locations in corridors or otherwise within the area of real space in many implementations. The data set of object events may be used for calibration of the presentation data. The presentation data may include the object events, or be related to the object events. In one implementation, the presentation data is a graphical construct indicating activity related to the particular object in multiple locations, which can be displayed on a user device. The graphical construct may be a map with color-coding, for example. The graphical construct may also be a heat map. The graphical construct may be a time-lapse.

In some implementations, the calibrated presentation data is presented to a detected subject via a user interface, which may be a public display via a display device like a TV or monitor screen or a user device like a smart phone, tablet, computer, etc. The user interface may be a touch-screen display or otherwise configured to receive user inputs. The user interface can be configured to receive a user input (e.g., from the detected subject or responsive to the presentation data). In one implementation, the user interface is configured to receive a user input from the detected subject in order for the detected subject to accept personalized presentation data. In another implementation, personalized presentation data is displayed to the detected subject via a user interface, and the user interface is configured to receive other user input from the detected subject, like providing survey responses or requests for additional information in the format of providing contact information for retailing data, requesting to view more information, or scanning a QR code with their personal device. In some implementations, future personalized presentation data is triggered in dependence on the user input received from the detected implementation. In many implementations, the calibrated presentation data is further calibrated in dependence on the received user input.

Other implementations may include a non-transitory computer readable storage medium storing instructions executable by a processor to perform a method as described above. Yet another implementation may include a system including memory and one or more processors operable to execute instructions, stored in the memory, to perform a method as described above.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the disclosed implementations.

We claim as follows:

1. A computer-implemented method of providing presentation data to a subject in an area of real space, the method comprising:
obtaining, from a plurality of sensors, respective sequences of frames of corresponding fields of view in an area of real space;
detecting a subject in the area of real space;
analyzing a sequence of frames of the respective sequences of space, wherein the analyzing includes (i) identifying objects in the area of real space, (ii) identifying subject data of the detected subject with respect to the identified objects, wherein the subject data relates to one or more of: a location of the detected subject, a path of the detected subject, a velocity of the detected subject, an orientation of the detected subject, and an action of the detected subject, and (iii) identifying a connection between the identified subject data of the detected subject and a particular identified object;
calibrating the presentation data in dependence on the identified connection between the identified subject data of the detected subject and the particular identified object; and
triggering a presentation of the calibrated presentation data to the detected subject.

2. The computer-implemented method of claim 1, wherein the action of the detected subject includes the detected subject altering a location or a position of any identified object.

3. The computer-implemented method of claim 1, wherein the subject data of the detected subject further relates to one or more of: a connection of the detected subject with other identified objects, and a connection between the detected subject and another detected subject.

4. The computer-implemented method of claim 1, further including predicting, based on the path of the detected subject, a future path trajectory of the detected subject.

5. The computer-implemented method of claim 1, further including identifying a connection between the particular identified object and another identified object.

6. The computer-implemented method of claim 5, wherein the presentation data is further calibrated in dependence on the identified connection between the particular identified object and another identified object.

7. The computer-implemented method of claim 1, further including analyzing a visual association field of the detected subject,
wherein the visual association field is segmented into at least two regions within the visual association field, and
wherein a visual association of the detected subject with respect to a region within the visual association field is measured in dependence upon a head orientation of the detected subject, and wherein the at least two regions within the visual association field are assigned weights in dependence upon the visual association of the detected subject with a respective region relative to the other regions of the visual association field.

8. The computer-implemented method of claim 1, wherein identifying the connection between the identified subject data of the detected subject and the particular identified object further includes correlating the identified subject data of the detected subject with the particular identified object and classifying the identified subject data of the detected subject as being connected to the particular identified object.

9. The computer-implemented method of claim 1, wherein identifying a connection between the identified subject data of the detected subject and another identified object further includes determining that the identified subject data of the detected subject is uncorrelated with the other identified object and classifying the identified subject data of the detected subject as being unconnected to the other identified object.

10. The computer-implemented method of claim 1, further including using a sequence of frames produced by a corresponding sensor in the plurality of sensors in a first inference engine to identify objects in the sequence of frames.

11. The computer-implemented method of claim 10, further including using outputs of the first inference engine over a period of time in a second inference engine to identify the subject data of the detected subject.

12. The computer-implemented method of claim 1, further including monitoring a quantity of the particular identified object located within the area of real space, wherein the calibration of the presentation data is further dependent upon the quantity of the particular identified object.

13. The computer-implemented method of claim 1, further including:
producing subject events that occur in the area of real space corresponding to the identified subject data of the detected subject, each of the subject events including one or more of a subject identifier of the detected subject, particular identified subject data of the detected subject, a location in the area of real space, and a timestamp;
constructing a chronologically ordered sequence of subject events associated with the detected subject; and
calibrating the presentation data in dependence on the chronologically ordered sequence of subject events associated with the detected subject.

14. The computer-implemented method of claim 1, wherein identifying the connection between the identified subject data of the detected subject and the particular identified object further includes:
correlating the identified subject data of the detected subject with a region in the area of real space;
identifying a set of one or more identified objects associated with the region, wherein the set of one or more identified objects includes the particular identified object;
producing a connection probability with respect to each identified object within the set of identified objects, wherein each respective connection probability corresponds to a likelihood that the identified subject data of the detected subject is connected to a respective identified object; and
selecting the identified object within the set of identified objects having the highest connection probability as the particular identified object.

15. The computer-implemented method of claim 1, further including:
identifying other subject data of the detected subject and another connection between the other subject data of the detected subject and another identified object;
further calibrating the calibrated presentation data in dependence on the other connection between the other subject data of the detected subject and the other identified object; and
triggering a presentation of the further calibrated presentation data to the detected subject.

16. The computer-implemented method of claim 1, wherein the calibrated presentation data is presented to the detected subject via a user interface, and wherein the user interface is configured to receive a user input from the detected subject responsive to the calibrated presentation data.

17. The computer-implemented method of claim 16, wherein the calibrated presentation data is further calibrated in dependence on the received user input.

18. The computer-implemented method of claim 1, further including receiving subject data provided by the detected subject, and calibrating the presentation data based on the received subject data.

19. A system for presenting providing presentation data to a subject in an area of real space, the system including one or more processors coupled to memory, the memory being loaded with computer instructions that, when executed on the processors, implement actions comprising:
obtaining, from a plurality of sensors, respective sequences of frames of corresponding fields of view in an area of real space;
detecting a subject in the area of real space;
analyzing a sequence of frames of the respective sequences of space, wherein the analyzing includes (i) identifying objects in the area of real space, (ii) identifying subject data of the detected subject with respect to the identified objects, wherein the subject data relates to one or more of: a location of the detected subject, a path of the detected subject, a velocity of the detected subject, an orientation of the detected subject, and an action of the detected subject, and (iii) identifying a connection between the identified subject data of the detected subject and a particular identified object;
calibrating the presentation data in dependence on the identified connection between the identified subject data of the detected subject and the particular identified object; and
triggering a presentation of the calibrated presentation data to the detected subject.

20. A non-transitory computer readable storage medium storing computer program instructions for providing presentation data to a subject in an area of real space, the instructions, when executed on a processor, causing the processor to implement a method comprising:
obtaining, from a plurality of sensors, respective sequences of frames of corresponding fields of view in an area of real space;
detecting a subject in the area of real space;
analyzing a sequence of frames of the respective sequences of space, wherein the analyzing includes (i) identifying objects in the area of real space, (ii) identifying subject data of the detected subject with respect to the identified objects, wherein the subject data relates to one or more of: a location of the detected subject, a path of the detected subject, a velocity of the detected subject, an orientation of the detected subject, and an action of the detected subject, and (iii) identifying a connection between the identified subject data of the detected subject and a particular identified object; and
triggering a presentation of the calibrated presentation data to the detected subject.
